(19) United States
(12) Patent Application Publication
(10) Pub. No.: US 2004/0038022 A1
(43) Pub. Date: Feb. 26, 2004

(54) Method of making a polypropylene fabric having high strain rate elongation and method of using the same

(76) Inventors: Rexford A. Maugans, Lake Jackson, TX (US); Kalyan Sehanobish, Friendswood, TX (US); Michael E. Rowland, Lake Jackson, TX (US); Ray A. Herring, Lake Jackson, TX (US); John Kaarto, Missouri City (CA); Kenneth E. Springs, Clute, TX (US); Thoi H. Ho, Lake Jackson, TX (US)

Correspondence Address: JENKENS & GILCHRIST, 1401 MCKINNEY, SUITE 2700, HOUSTON, TX, 77010, US

(21) Appl. No.: 10/240,291

(22) PCT Filed: Mar. 27, 2001
(86) PCT No.: PCT/US01/09801

(30) Foreign Application Priority Data
Mar. 27, 2000 (US) 60192295

(51) Int. Cl. B32B 27/00; B32B 1/00

(52) U.S. Cl. 428/328; 428/394; 428/409; 156/229; 156/62.6

(57) ABSTRACT

This invention relates to a method of making a film-fabric composite (includinng a film-fabric laminate) wherein the fabric is characterized as having improved tensile elongation (without rupture). In particular, the invention pertains to a method of making a film-fabric laminate having structual elastic-like behavior wherein the fabric is a nonwoven thermally bonded fabric characterized as having improved high strain rate tensile elongation and comprises a plurality of fibers comprised of at least one polypropylene polymer and at least one ethylene polymer, wherein the method comprises stretching the laminate at a high strain rate. The improved farbic is characterized by higher high strain rate tensile properties and a broader bond window which is also shifted to substantially lower temperatures with regard to maximum tensile properties. The improved fabric enables higher stretching levels or speeds on stretching apparati often employed to impart elasticity or elastic-like behavior to inelastic ploymeric materials. Polypropylene copolymers as well as polypropylene homopolymers may be used in the invention which is sueful for durable and disposable articles such as diapers, bandages, pantiliners, continence pads, and sanitary napkins.

### CROSS REFERENCE TO RELATED APPLICATIONS

This application is a 371 of PCT/US01/90801, filed Mar. 27, 2001, which claims priority to U.S. Provisional Application Serial No. 60/192,295, filed Mar. 27, 2000, both of which are incorporated by reference herein in their intirety.

### FIELD OF THE INVENTION

This invention relates to a method of making a film-fabric composite (including a film-fabric laminate) wherein the fabric is characterized as having improved tensile elongation (without rupture). In particular, the invention pertains to a method of making a film-fabric laminate having structual elastic-like behavior wherein the fabric is a nonwoven thermally bonded fabric characterized as having improved high strain rate tensile elongation and comprises a plurality of fibers comprised of at least one polypropylene polymer and at least one ethylene polymer, wherein the method comprises stretching the laminate at a high strain rate. The improved fabric is characterized by higher high strain rate tensile properties and a broader bond window which is also shifted to substantially lower bond temperatures with regard to maximum tensile properties. The improved fabric enables higher levels of stretching on stretching apparati often employed to impart elasticity or elastic-like behavior to inelastic polymeric materials. The invention also enables higher stretching rates or speeds. Polypropylene copolymers as well as polypropylene homopolymers may be used in the invention which is useful for durable and disposable articles such as diapers, bandages, pantiliners, continence pads, and sanitary napkins.

### BACKGROUND OF THE INVENTION

Sisson in U.S. Pat. Nos. 4,107,364 and 4,209,563 teaches lightweight to heavy zero strain stretch laminate webs comprised of synthetic polymers that are well suited for disposable applications. Sisson's teaching of bulking and bunching of permanently elongated plies in the z-direction to affect zero strain elasticity has been followed by several workers.

Roe et al. in U.S. Pat. No. 5,947,948 describe absorbent articles such as diapers which comprise a structural elastic-like film web which exhibits an elastic-like behavior in the direction of elongation without the use of added elastic materials. Roe et al. teach that their web may comprise a polymer blend of polyethylene (for example, linear low density polyethylene, ultra low density polyethylene and high density polyethylene) and polypropylene, but tensile testing is reported at 10 inches per minute.

Schwarz in U.S. Pat. No. 4,223,059 describes selectively stretching nonwoven and spunbonded webs in incremental portions with sets of parallel and perpendicular grooved rolls for improved strength. Examples include relatively low surface velocities (that is, up to 6.1 meter per minute) and do not include any polymer blends.

Sabee in U.S. Pat. No. 4,223,063 describes a process for differentially drawing film-fiber webs for improved web drapability and strength. The process involves subjecting the web to two or more pairs of meshing toothed rollers or gears to stretch the web to provide tensile deformation (rather than embossment or compression deformation) and a patterned fabric. Sabee describes suitable web materials as including polymer blends but there is no reported example with the described process being operated at a high strain rate.

Sneed et al. in U.S. Pat. No. 4,517,714 describe a process for making a nonwoven fabric barrier layer using grooved rolls in a ring-rolling technique. The examples describe interdigitating grooved roll speeds up to only 31 feet per minute. Moreover, no polymer blend appears to be described, nor are any tensile property data provided.

Sabee in U.S. Pat. No. 4,834,741 teaches the maximum stretching to which a polymeric web can be subjected to is limited by the onset of destructive breaking, rupturing, or tearing. Further, Sabee indicates that for certain applications it is desirable to controllably stretch and rupture nonelongateable or nondrawable elements in webs to achieve characteristics like softness and enhanced porosities.

Buell et al. in U.S. Pat. No. 5,151,092 describe zero strain stretch laminates as elastomeric laminates. In U.S. Pat. No. 5,156,793, Buell et al. describe a method for mechanically and incrementally stretching zero strain stretch laminate webs to impart nonuniform elasticity, even from inelastic webs. The zero strain stretch laminate web comprises at least two plies of material that are secured to one another, either intermittently, or substantially continuously, along at least a portion of their coextensive surfaces while in a substantially untensioned (“zero strain”) condition. One of the plies is typically comprised of a stretchable, elastomeric material (that is, the material will substantially return to its untensioned dimensions after an applied tensile force has been released). The other ply secured to the stretchable, elastomeric ply is elongatable, most preferably drawable, but is not necessarily elastomeric. The mechanical stretching is affected by passing laminate webs between at least one pair of meshing corrugated rolls having nonuniform profiles. For diapers, Buell et al. describe the backsheet as typically comprising an elongatable polymeric material such as one mil thick polyethylene film. For the backsheet, polymer blends comprising about 44-90% linear low density polyethylene and about 10-55% polypropylene are said to be preferred. The topsheet (fabric) is taught to typically comprise either an elongatable nonwoven fibrous material or an elongatable apertured polymeric film. One particularly preferred topsheet comprises 2.2 denier nonwoven polypropylene fibers. Buell et al. teach polypropylene structures typically show lower elongation at break (or peak) than similar structures made with polyethylene and, accordingly, polypropylene elongation performance is considered process and product limitation. Buell et al. teach intermittent bonding helps avoid elogation rupture of polypropylene fabric webs during stretching.

In U.S. Pat. No. 5,156,793, Buell et al. also describe an apparatus for selective stretching laminated fabric-film structures between teeth in rolls. Buell describes an example of sharp teeth in his stretching device (rolls) that are 0.15 inches apart and 0.30 inches deep. If such teeth were positioned along the axis of two foot diameter rolls, and film-fabric structures were passed between them at 500 feet per minute and the teeth were 50% engaged, then the average strain rate for the stretching would be roughly 10,000% per second. Structures passing between eight inch rolls at 170 ft per minute would have similar stretching strain rates. While changes in roll size, teeth geometry, line speed and percent penetration will all affect the stretching rate, the device can assuredly operate at signifcantly higher strain rates than the 6-18%/second strain rate customary for two inch specimens in the standard 5-20 inch/minute (physical displacement rate) ASTM tensile test, although not specifically shown to. Nonetheless, teeth geometry description notwithstanding, there is no reported tensile data for any material at any strain rate.

Chappell et al. in U.S. Pat. No. 5,518,801 describe web materials having an elastic-like behavior when subjected to an applied and subsequently released elongation along at least one axis. Chappell et al. teach that web materials may comprise polyethylene or polypropylene and blends thereof as well as metallocene catalyst-based polymers. But Chappel et al. only report tensile data at a 10 in/min physical deformation rate.

Harrington et al. in U.S. Pat. No. 5,985,193 describe a process for making skin-core fibers and nonwoven article comprising such fiber wherein the fibers are composed of a polymer blend, including a polypropylene polymer blended with XU-58200.02 ethylene polymer manufactured using INSITE™ constrained geometry catalyst technology as supplied by the Dow Chemical Company. But there is no disclosure of high strain rate testing as tensile elongation testing is reported at an extension (strain) rate of 200%/minute.

Fiber is typically classified according to its diameter. Monofilament fiber is generally defined as having an individual fiber diameter greater than 15 denier, usually greater than 30 denier per filament. Fine denier fiber generally refers to a fiber having a diameter less than 15 denier per filament. Microdenier fiber is generally defined as fiber having less than 100 microns diameter (as 1 denier equals [microns/2]²×0.026). Fiber can also be classified by the process by which it is made, such as monofilament, continuous wound fine filament, staple or short cut fiber, spunbond, and melt blown fiber. A nonwoven web comprising plurality of fibers is referred to as a fabric.

A variety of fibers and fabrics have been made from thermoplastics, such as polypropylene, highly branched low density polyethylene (LDPE) made typically in a high pressure polymerization process, linear heterogeneously branched polyethylene (for example, linear low density polyethylene made using Ziegler catalysis), blends of polypropylene and linear heterogeneously branched polyethylene, blends of linear heterogeneously branched polyethylene, and ethylene/vinyl alcohol copolymers.

Of the various polymers known to be extrudable into fiber, highly branched LDPE has not been successfully melt spun into fine denier fiber. Linear heterogeneously branched polyethylene has been made into monofilament, as described in U.S. Pat. No. 4,076,698 (Anderson et al.). Linear heterogeneously branched polyethylene has also been successfully made into fine denier fiber, as disclosed in U.S. Pat. No. 4,644,045 (Fowells), U.S. Pat. No. 4,830,907 (Sawyer et al.), U.S. Pat. No. 4,909,975 (Sawyer et al.) and in U.S. Pat. No. 4,578,414 (Sawyer et al.). Blends of such heterogeneously branched polyethylene have also been successfully made into fine denier fiber and fabrics, as disclosed in U.S. Pat. No. 4,842,922 (Krupp et al.), U.S. Pat. No. 4,990,204 (Krupp et al.) and U.S. Pat. No. 5,112,686 (Krupp et al.). U.S. Pat. No. 5,068,141 (Kubo et al.) also discloses making nonwoven fabrics from continuous heat bonded filaments of certain heterogeneously branched LLDPE having specified heats of fusion. While various teachings describe the use of ethylene polymers as blend components for polypropylene-based fabric, Applicants believe there is no teaching of the utility of blending with ethylene polymers for improved high strain rate tensile properties.

U.S. Pat. Nos. 5,294, 492 and 5,593,768 (Gessner) describe a multiconstituent fiber having improved thermal bonding characteristics composed of a blend of at least two different thermoplastic polymers. Examples (and presumably FIG. 1 therein) consist of polypropylene polymer blended with ASPUN™ fiber grade LLDPE resins having a 12 or 26 g/10 minute I₂ melt index as supplied by The Dow Chemical Company, each manufactured using a conventional Ziegler catalyst system. The example polypropylene polymer used by Gessner was described a “controlled rheology” PP (that is, a visbroken PP) having a melt flow rate of 26 and at least 90 percent by weight isotacticity. But Gessner does not report any high strain rate tensile data.

U.S. Pat. No. 5,549,867 (Gessner et al.) describes the addition of a low molecular weight (that is, high melt index or melt flow) polyolefin to a polyolefin with a molecular weight (Mz) of from 400,000 to 580,000 to improve spinning. The Examples set forth in Gessner et al. are all directed to blends of 10 to 30 weight percent of a lower molecular weight metallocene polypropylene with from 70 to 90 weight percent of a higher molecular weight polypropylene produced using a Ziegler-Natta catalyst. But Applicants do not believe that Gessner et al. describe mechanical performance at high strain rates.

U.S. Pat. No. 4,839,228 (Jezic et al.) describes biconstituent fibers having improved tenacity and hand composed of a highly crystalline polypropylene polymer with LDPE, HDPE or preferably LLDPE. The polyethylene resins are described to have a moderately high molecular weight wherein their I₂ melt index is in the range of from about 12 to about 120 g/10 minutes. But Jezic et al. do not describe tensile properties measured at high strain rates.

Also, fibers made from blends of visbroken polypropylene polymer and homopolymer high density polyethylene (HDPE) having an I₂ melt index of equal to greater than 5 g/10 minutes are known. Such blends are thought to function on the basis of the immiscibility of the olefin polymers but are not particularly known as having high strain tensile elongation.

WO 95/32091 (Stahl et al.) discloses a reduction in bonding temperatures by utilizing blends of fibers produced from polypropylene resins having different melting points and produced by different fiber manufacturing processes, for example, meltblown and spunbond fibers. Stahl et al. claims a fiber comprising a blend of an isotactic propylene copolymer with a higher melting thermoplastic polymer. But Stahl et al. do not report any high strain tensile data.

WO 96/23838, U.S. Pat. No. 5,539,056 and U.S. Pat. No. 5,516,848 teach blends of an amorphous poly-α-olefin of Mw>150,000 (produced via single site catalysis) and a crystalline poly-α-olefin with Mw<300,000, (produced via single site catalysis) in which the molecular weight of the amorphous polypropylene is greater than the molecular weight of the crystalline polypropylene. Preferred blends are described to comprise about 10 to about 90 weight percent of amorphous polypropylene. The described blends are said to exhibit unusual elastomeric properties, namely an improved balance of mechanical strength and rubber recovery properties. But there appears to be no disclosure of high strain rate performance.

U.S. Pat. No. 5,483,002 and EP 643100 teach blends of a semi-crystalline propylene homopolymer having a melting point of 125 to 165° C. and a semi-crystalline propylene homopolymer having a melting point below 130° C. or a non-crystallizing propylene homopolymer having a glass transition temperature which is less than or equal to −10° C. These blends are said to have improved mechanical properties, notably impact strength. But Applicants believe there is no disclosure of high strain rate performance.

Crystalline polypropylenes produced by single site catalysis have been reported to be particularly suited for fiber production. Due to narrow molecular weight distributions and low amorphous contents, higher spinning rates and higher tenacities have been reported. But, isotactic PP fibers, in general (and particularly when produced using single site catalyst) exhibit poor bonding performance and are not known to exhibit good high strain rate tensile elongation.

U.S. Pat. No. 5,677,383 (Lai et al.) discloses blends of (A) at least one homogeneously branched ethylene polymer having a high slope of strain hardening coefficient and (B) at least one ethylene polymer having a high polymer density and some amount of a linear high density polymer fraction. The Examples set forth by Lai et al. are directed to substantially linear ethylene interpolymers blended with heterogeneously branched ethylene polymers. Lai et al. describe the use of their blends in a variety of end use applications, including fibers. The disclosed compositions preferably comprise a substantially linear ethylene polymer having a density of at least 0.89 grams/ centimeters³. But Lai et al. do not describe blends comprising polypropylene, nor they report any high strain rate performance data.

### SUMMARY OF THE INVENTION

While various polymer blend compositions have found success in a number of fiber and fabric applications, the fibers and fabrics made from such compositions would benefit from an improvement in elongation and tensile strength, which would lead to stronger fabrics, and increased value to the fabric and article manufacturers, as well as to the ultimate consumer. Also, a broadening of the thermal bonding window while maintaining or improving tensile performance would improve the ability to produce higher performance fabric in a practical fabric production operation as well as provide energy savings and improved fabric integrity. But perhaps most importantly, fabrics with significantly improved tensile properties will enable the utilization of significantly higher stretching rates on equipment designed to impart elasticity or elastic-like behavior to inelastic materials such as the apparatus described by Buell et al. in U.S. Pat. No. 5,156,793.

We have discovered that the addition of an ethylene polymer into a polypropylene polymer can dramatically improve the high strain rate elongation and tensile properties of resultant nonwoven fibrous fabric. Accordingly, the subject invention provides a method of making a nonwoven bonded fabric characterized as having improved high strain rate tensile elongation and comprising a plurality of fibers, the fibers comprising (preferably a melt blend) of at least one polypropylene polymer (or copolymer) and at least one ethylene polymer (or copolymer).

In certain embodiments, the method comprises thermally bonding the fabric at a temperature of from 15 to 20° F. lower than optimum bonding temperature of a comparative fabric (measured at normal strain rates), wherein the comparative fabric is essentially the same as the inventive fabric, except the addition of the at least one ethylene polymer. That is, the inventive fabric and the comparative fabric are substantially identical but for the absence of the at least one ethylene polymer; they comprise the same polypropylene polymer, have the same basis weight (±10% or less), fiber denier (±10% or less), and other ingredients and are manufactured in same manner using the same equipment, equipment settings, and the like. The bond temperature differential would be 5 to 10° F. lower (rather than 15 to 20° F. lower) where measuring and comparing both performances at a high strain rate.

In another aspect, the invention is a method of making a film-fabric laminate at a high strain rate to impart elasticity or structual elastic-like behavior wherein the fabric is a nonwoven thermally bonded fabric characterized as having improved high strain rate tensile elongation and comprises a plurality of fibers comprised of a melt blend of at least one polypropylene polymer (or copolymer) and at least one ethylene polymer (or copolymer), wherein the film is elongatable (but not necessarily elasticity) and the method comprises stretching the laminate at a high strain rate.

Preferably, the film is elastic at low strain levels (for example, a strain level of 15-20%) and inelastic at high strain levels (for example, greater than 150%).

The polypropylene polymer is preferably a polypropylene polymer having a melt flow rate (MFR) in the range of from 1 to less than 1000 grams/10 minutes, measured in accordance with ASTM D1238 at 230° C./2.16 kg, more preferably in range of 5 to 100 grams/10 minutes.

Preferably, the ethylene polymer is a homogeneously branched ethylene polymer, more preferably it is a substantially linear ethylene/α-olefin interpolymer characterized having:

i. a melt flow ratio, I₁₀/I₂,≧5.63,

ii. a molecular weight distribution, M_{w}/Mₙ, defined by the equation:

M_{w}/Mₙ, ≦(I₁₀/I₂)−4.63, and

iii. a critical shear rate at onset of surface melt fracture of at least 50 percent greater than the critical shear rate at the onset of surface melt fracture of a linear ethylene polymer having about the same I₂ and M_{w}/Mₙ.

The ethylene polymer is preferably employed at from 0.5 percent to 25 weight percent, especially at greater than or equal to 3 weight percent, more especially at greater than or equal to 5 weight percent preferably greater than or equal to 7.5 weight percent, more preferably at greater than or equal to 10 weight percent, and most preferably in the range of 7.5 to 20 weight percent, based on the total weight of the polypropylene polymer and the ethylene polymer.

In regard to weight percent and the melt index or melt flow rate of polymers, practitioners will recognize that the present invention requires a balancing of improved bond performance and good spinnability. For example, in general, depending on the I₂ melt index of the ethylene polymer, such as when less than 2 g/10 minutes, at levels higher than 25 weight percent, the spinnability or drawability of fibers can be adversely affected.

The improved fabric enables successful utilization of high rate stretching apparati for the manufacturing of durable and disposable nonwoven composite articles such as diapers, bandages, pantiliners, continence pads, and sanitary napkins. In particular, our invention addresses the fabric elongation limitations and the strain rates that would likely apply during the stretching process described by Buell in U.S. Pat. No. 5,156,793.

As an unexpected surprise, we discovered that blending an ethylene polymer into a polypropylene polymer can dramatically improve the high strain rate fabric elongation and tensile strength of thermally bonded fibers to the extent that elongation substantially increases, the bonding window for maximum elongation substantially broadens as well as shifts to lower temperatures versus improvement results obtainable at normal strain rates as well as versus an equivalent polypropylene fabric, except for the ethylene polymer (that is, a comparative fabric). For example, a certain 20 gsm fabric consisting of a polypropylene homopolymer exhibited a tensile elongation performance maximum at 290° F. when measured at a strain rate of 6%/second. But surprisingly when blended with an ethylene polymer and measured at high strain rates, the corresponding bond window was substantially broader and the temperature at maximum tensile elongation was 270° F.

As another surprise, in certain embodiments, substantial improvements are obtained even for a polypropylene polymer with high melt flow rates (MFRs). This result was surprisingly because ordinarily one would expect polymers with higher MFRs to show proportionally lower tensile properties yet in comparative tests showed dramatic improvements.

As another surprise, in situ blend modified compositions (that is, polymer blend compositions made by simultaneously melt blending in an ethylene polymer while rheology-modifying the polypropylene polymer) exhibited substantially improved high strain rate elongation and shifted bond windows in spite of MFR differences for the base polypropylene polymers. That is, in comparative testing, both a 25 MFR in situ blend modified composition and a 35 MFR in situ blend modified composition with 10 weight percent of an ethylene polymer, exhibited substantially improved, equivalent tensile property performance when measured at high strain rates.

As added benefit, spinning is significantly better with more intensely mixed blends, described above, versus a pellet blend of the same composition fed to the spinning unit. Accordingly, in preferred embodiments of the invention, the polypropylene polymer and the ethylene polymer are intensely melt blended such as with a twin-screw extruder, for example, at a melt temperature above their respective crystalline melting points.

The fibers and fabrics of the invention can be produced on conventional synthetic fiber or fabric processes (for example, carded staple, spun bond, melt blown, and flash spun) and they can be used to produce fabrics having high elongation and tensile strength, without a significant sacrifice in fiber spinnability.

These and other embodiments are more fully described in the detailed description in conjunction with the following figures.

### BRIEF DESCRIPTION OF THE DRAWINGS

FIG. 1 is diagram of a preferred twin-screw extruder for making the melt blend of the invention.

FIG. 2 is a plot of Cross-Direction (CD) Percent Elongation of a 20 gsm fabric measured at a 6%/second strain rate versus Thermal Bonding Temperature (in ° F.) for Example 1, Example 2, Example 3, comparative run 1 and comparative run 2.

FIG. 3 is a plot of Cross-Direction (CD) Tensile Strength of a 20 gsm fabric measured at a 6%/second strain rate versus Thermal Bonding Temperature (in ° F.) for Example 1, Example 2, Example 3, comparative run 1 and comparative run 2.

FIG. 4 is a plot of Cross-Direction (CD) Percent Elongation of a 20 gsm fabric measured at a 11,000%/second strain rate versus Thermal Bonding Temperature (in ° F.) for Example 1, Example 2, Example 3, comparative run 1 and comparative run 2.

FIG. 5 is a plot of Cross-Direction (CD) Tensile Strength of a 20 gsm fabric measured at a 11,000%/second strain rate versus Thermal Bonding Temperature (in ° F.) for Example 1, Example 2, Example 3, comparative run 1 and comparative run 2.

FIG. 6 is a plot of Machine-Direction (MD) Percent Elongation of a 20 gsm fabric measured at a 10,333%/second strain rate versus Thermal Bonding Temperature (in ° F.) for Example 1, Example 2, Example 3, comparative run 1 and comparative run 2.

FIG. 7 is a plot of Machine-Direction (MD) Tensile Strength of a 20 gsm fabric measured at a 10,333%/second strain rate versus Thermal Bonding Temperature (in ° F.) for Example 1, Example 2, Example 3, comparative run 1 and comparative run 2.

FIG. 8 is a plot of Cross-Direction (CD) Percent Elongation of a 30 gsm fabric measured at a 10,667%/second strain rate versus Thermal Bonding Temperature (in ° F.) for Example 4, Example 5, comparative run 3 and comparative run 4.

### DETAILED DESCRIPTION OF THE INVENTION

“Normal strain rates” are defined herein as strain rates less than 20%/second. Such rates are typical in ordinary ASTM testing. Conversely, “high strain rates” are defined herein as strain rates greater than 100%/second, especially greater than 500%/second, more especially greater than 1000%/second, and most especially greater than 10,000%/second, and most preferably as strain rates in the range of from 10,000 to 11,000%/second.

The term “elongatable” is used herein in reference any material which, upon application of a biasing or tensile force at a strain rate of 6-8%/second, elongates at least 50 percent (that is, to a stretched, tensioned length which is at least 150 percent of its relaxed untensioned length), and which, will recover at least 55 percent of its elongation upon release of the force. A hypothetical example would be a one (1) inch sample of a material which is elongated or stretched to at least 1.50 inches and which, upon being elongated to 1.50 inches and released, will recover to a length of not more than 1.23 inches. Many elastic materials maybe elongated by much more than 50 percent (that is, much more than 150 percent of their relaxed untensioned length), for example, elongated 100 percent or more, and many of these materials will recover to substantially their initial relaxed length, for example, to within 105 percent of their original relaxed length, upon release of the stretching force. Thus, the term elongatable does not exclude elastic materials nor inelastic material.

The term “elastic” or “elastic-like behavor” as used herein refers to any material (for example, bands, ribbons, striips, sheets, coatings, films, filament, fibers, fibrous webs and the like as well as laminates including the same) that recovers at least 50% after being stretched to 150% or more of its original length. Elasticity can also be described in terms of “permanent set” as “permanent set” is the converse of elasticity. The extent that a material does not return to its original dimensions after being stretched is its percent permanent set. Materials with a permanent set of less than 10 percent when stretched to 150% or more of their original lengths, are considered “highly elastic.”

As used herein, the term “inelastic” refers to any material (for example, bands, ribbons, striips, sheets, coatings, films, filament, fibers, and fibrous webs) that after being stretched to 150% or more of its original length at a temperature between its glass transition temperature and its crystalline melting point or range and subsequently released, results in a permanent elongation equal to 25% or more of the stretch applied.

The term “thermal bonding” is used herein refers to the heating of fibers to effect the melting (or softening) and fusing of fibers such that a nonwoven fabric is produced. Thermal bonding includes calendar bonding and through-air bonding as well as methods known in the art.

The term “optimum bonding temperature” is that bond temperature where a fabric measures its maximum tensile properties. The particular temperature is typically different with respect to maximum tensile elongation versus maximum tensile strength and typically the optimum bond temperature for maximum tensile elongation is lower than that for maximum tensile strength.

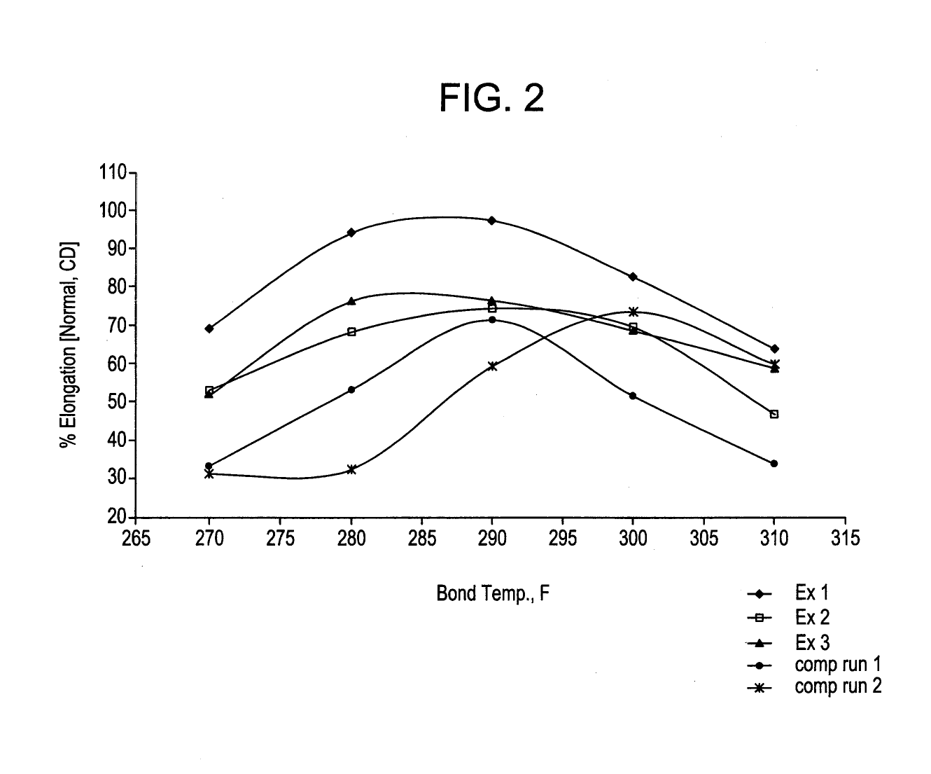

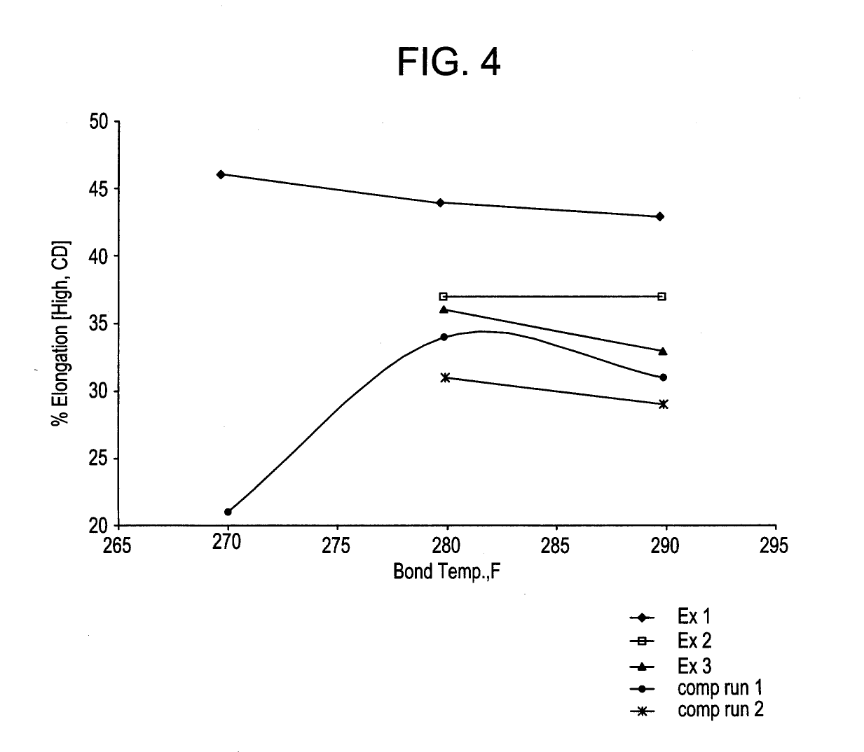

The terms “bond window” or “optimum bond window”, as used herein, refer to the temperature range wherein the change in tensile properties with respect to maximum performance is equal to or greater than 0.94 (that is, no less than 6% below the maximum). For example, referring to FIG. 2, for Example 1 measured at a normal strain rate, maximum elongation is 101% occurring at 287° F. Accordingly, the bond window is 279° F. to 295° F. (from 101%×0.94=95% elongation which from FIG. 2 corresponds to from 279° F. to 295° F.). Also, for example, from FIG. 4, the bond window for Example 1 measured at a high strain rate is believed to be at least 40° F. ranging from (by extrapolation) 250° F. to 290° F. with peak elongation performance occurring at 270° F.

The term “structural elastic-like behavior” is used herein as it is known in the art to refer to bunching or bulking of material or both in an untensioned condition such that when tensioned, the material may be extended without permanent deformation resulting and then return substantially to its untensioned dimensions when the tension is released. The term includes reference to a composite or laminate.

The term “laminate” as used herein refers to a structure comprising at least two plies of material. At least one of the plies may be a film and the another may be a fabric. Preferably (but not necessarily) the at least two plies are secured to one another by an adhesive, glue, other bonding technique or a combination thereof.

A “composite” is an article that comprises different materials, at least one of which is a fabric. Accordingly, the term “composite” encompasses a laminate as well as a laminate in combination with at least one other material.

The term “fabric” as used herein refers to a structure comprising a plurality of fibers that are interconnected. The interconnecting is preferably accomplished by bonding (that is, fusing fibers together), preferably thermal bonding, more preferably by an intermittent spot thermal bonding technique, especially using heat rollers having configured or profiled surfaces.

The terms “visbroken” and “viscracked” are used herein in their conventional sense to refer to a reactor grade or product polypropylene polymer which is subsequently cracked or chain-scissioned prior to, during or by extrusion to provide a substantially higher melt flow rate. In the present invention, a viscracked polypropylene polymer will show a MFR change of at least 10:1, especially, at least 20:1 and more especially at least 25: 1 in respect to the ratio of its subsequent MFR to initial MFR. For example, but the invention is not limited thereto, a reactor grade polypropylene polymer having a MFR of 4 can be used in the present invention where it is visbroken or viscracked to a MFR greater than 20 (that is, having a >20 visbroken MFR) prior to, during or by extrusion (for example, in an extruder immediately prior to a spinneret) in a conventional fiber making operation. In the present invention, to facilitate visbreaking, an initiator such as a peroxide (for example, but not limited to, Lupersol™ 101) and optionally antioxidant can be compounded with the initially low MFR polypropylene polymer prior to fiber making. In one embodiment, the polypropylene polymer is provided in powder form (or small microspheres) and the peroxide, antioxidant and ethylene polymer are admixed via a side-arm extrusion at the polypropylene polymer manufacturing facility. This embodiment, which generally comprises the simultaneous combination of visbreaking and melt blending, is referred to herein as “in situ blend modified”.

Polypropylene polymers having a visbroken melt flow rate (but not blended with another olefin polymer in a single extrusion step that includes peroxide addition such as the case for in situ blend modified compositions) are also referred to in the art as “controlled rheology polypropylene” (see, for example, Gessner in U.S. Pat. No. 5,593,768) and initiator-assisted degraded polypropylene (see, for example, Polypropylene Handbook, Hanser Publishers, New York (1996)).

The term “reactor grade” is used herein in its conventional sense to refer to a virgin or additive modified polypropylene polymer which is not cracked or chain-scissioned after its initial production and as such its MFR will not be substantially changed during or by extrusion (for example, in an extruder immediately prior to a spinneret). In the present invention, reactor grade polypropylene will have MFR change during extrusion of less than 3:1, especially less than or equal to 2:1, more especially less than or equal to 1.5: 1, most especially less than or equal to 1.25:1 with respect to the ratio of the polymer's subsequent MFR to its initial (before extrusion) MFR. In the present invention, reactor grade polypropylene polymers characterized as having a subsequent to initial MFR ratio of less than or equal to 1.25:1 typically contain an effective thermal stabilizer system such as, for example, but not limited to, 1 total weight percent Irganox™ 1010 phenolic antioxidant or Irgafos™ 168 phosphite stabilizer or both. Reactor grade polypropylene polymers characterized as having a relative low subsequent to initial MFR ratio are referred to in the art as “constant rheology polypropylene” (see Jezic et al. U.S. Pat. No. 4,839,228).

The term “good spinnability” is used herein to refer to the ability to produce high quality fine denier fibers using at least semi-commercial equipment (if not commercial equipment) at at least semi-commercial production rates (if not commercial production rates). Representative of excellent spinnability is producing fine denier fiber at greater than or equal to 750 meters/minute without any drips using the spinnability test described by Pinoca et al. in U.S. Pat. No. 5,631,083.

The term “fine denier fiber” is used herein to refer to fibers having a diameter less than or equal to 50 denier.

The term “polymer” is used herein to refer a synthetic material having repeat units such as polyethylene and polypropylene. The term encompasses homopolymers, interpolymers, copolymers as well as terpolymers.

The term “interpolymer” is used herein to refer to polymers comprised of more than one monomer. Accordingly, the term encompasses copolymers and terpolymers and does not encompass homopolymer.

The term “homopolymer” is used herein to refer to a polymer comprised of only one monomer such ethylene in the case of high pressure, free-radical initiated low density polyethylene (LDPE).

The term “copolymer” is used herein to refer to a polymer comprised of two monomers such as an ethylene/propylene copolymer.

The term “terpolymer” is used herein to refer to a polymer comprised of three monomers such an ethylene/propylenc/butadiene terpolymer.

The polymer blend composition used to make the fiber and fabric of the present invention comprises at least one polypropylene polymer, preferably a crystalline polypropylene polymer. The polypropylene polymer can be coupled, branched, visbroken, rheology-modified or a reactor grade resin. Preferably, the inventive fabric can comprise up to 97 weight percent of at least one polypropylene polymer. In certain preferred embodiments, inventive fabric comprises equal to or greater than 95 weight percent, especially equal to or greater than 92.5 weight percent, more especially equal to or greater than 90 weight percent, and most especially equal to or greater than 80 weight percent of at least one polypropylene polymer.

A crystalline polypropylene polymer is a polymer with at least 90 mole percent of its repeating units derived from propylene, preferably at least 97 percent, more preferably at least 99 percent. The term “crystalline” is used herein to mean isotactic polypropylene having at least 93 percent isotactic triads as measured by ¹³C NMR, preferably at least 95 percent, more preferably at least 96 percent.

The polypropylene polymer comprises either homopolymer polypropylene or propylene polymerized with one or more other monomers addition polymerizable with propylene. The other monomers are preferably olefins, more preferably alpha olefins, most preferably ethylene or an olefin having a structure RCH═CH₂ where R is aliphatic or aromatic and has at least two and preferably less than 18 carbon atoms. Hydrocarbon olefin monomers within the skill in the art, include hydrocarbons having one or more double bonds at least one of which is polymerizable with the alpha olefin monomer.

Suitable alpha olefins for polymerizing with propylene include 1-butene, 1-pentene, 1-hexene, 1-octene, 1-heptene, 1-nonene, 1-decene, 1-unidecene, and 1-dodecene as well as 4-methyl-1-pentene, 4-methyl- 1-hexene, 5 -methyl-1-hexene, vinylcyclohexane, and styrene. The preferred alpha olefins include ethylene, 1-butene, 1-hexene, 1-octene and 1-heptene.

Optionally, but not in the most preferred embodiment of the present invention, the polypropylene polymer comprises monomers having at least two double bonds which are preferably dienes or trienes. Suitable diene and triene comonomers include 7-methyl-1,6-octadiene, 3,7-dimethyl- 1,6-octadiene, 5,7-dimethyl- 1,6-octadiene, 3,7,11-trimethyl-1,6,10-octatriene, 6-methyl-1,5-heptadiene, 1,3-butadiene, 1,6-heptadiene, 1,7-octadiene, 1,8-nonadiene, 1,9-decadiene, 1,10-undecadiene, norbomene, tetracyclododecene,or mixtures thereof, preferably butadiene, hexadienes, and octadienes, most preferably 1,4-hexadiene, 1,9-decadiene, 4-methyl-1,4-hexadiene, 5-methyl-1,4-hexadiene, dicyclopentactiene, and 5-ethylidene-2-norbornene.

Suitable polypropylenes are formed by means within the skill in the art, for example, using single site catalysts or Ziegler Natta catalysts. The propylene and optional alpha-olefin monomers are polymerized under conditions within the skill in the art, for instance as disclosed by Galli, et al., Angew. Macromol. Chem., Vol. 120,. 73 (1984), or by E. P. Moore, et al. in Polypropylene Handbook, Hanser Publishers, New York, 1996, particularly pages 11-98.

The polypropylene polymer used in the present invention is suitably of any molecular weight distribution (MWD). Polypropylene polymers of broad or narrow MWD are formed by means within the skill in the art. For fiber applications, generally a narrower MWD is preferred (for example, a M_{w}/Mₙ ratio or polydispersity of less than or equal to 3). Polypropylene polymers having a narrow MWD can be advantageously provided by visbreaking or by manufacturing reactor grades (non-visbroken) using single-site catalysis or both.

Polypropylene polymers for use in the present invention preferably have a weight average molecular weight as measured by gel permeation chromatography (GPC) greater than 100,000, preferably greater than 115,000, more preferably greater than 150,000, most preferably greater than 250,000 to obtain desirably high mechanical strength in the final product.

Preferably, the polypropylene polymer has a melt flow rate (MFR) in the range of 1 to 1000 grams/10 minutes, more preferably in range of 5 to 100 grams/10 minutes, as measured in accordance with ASTM D1238 at 230° C./2.16 kg.

In general, for fiber making, especially to ensure good fiber spinning, the melt flow rate of the polypropylene polymer is preferably greater than or equal to 20 g/10 minutes, more preferably greater than or equal to 25 g/10 minutes, and especially in the range of from 25 to 50 g/10 minutes, most especially from 30 to 40 g/ 10 minutes.

But specifically for staple fiber, the melt flow rate (MFR) of the polypropylene polymer is preferably in the range of 10 to 20 g/10 minutes. For spunbond fiber, the melt flow rate (MFR) of the polypropylene polymer is preferably in the range of 20 to 50 g/10 minutes. For melt blown fiber, the melt flow rate (MFR) of the polypropylene polymer is preferably in the range of 500 to 1500 g/10 minutes. For gel spun fiber, the melt flow rate (MFR) of the polypropylene polymer is preferably less than or equal to 1 g/10 minutes.

The polypropylene polymer used in the present invention can be branched or coupled to provide increased nucleation and crystallization rates. The term “coupled” is used herein to refer to polypropylene polymers which are rheology-modified such that they exhibit a change in the resistance of the molten polymer to flow during fiber making operation (for example, in the extruder immediately prior to the spinneret in a fiber spinning operation. Whereas “visbroken” is in the direction of chain-scission, “coupled” is in the direction of crosslinking or networking. An example of coupling is where a couple agent (for example, an azide compound) is added to a relatively high melt flow rate polypropylene polymer such that after extrusion the resultant polypropylene polymer composition attains a substantially lower melt flow rate than the initial melt flow rate. For the coupled or branched polypropylene used in the present invention the ratio of subsequent MFR to initial MFR is preferably less than or equal to 0.7:1, more preferably less than or equal to 0.2:1.

Suitable branched polypropylene for use in the present invention is commercially available for instance from Montell North America under the trade designations Profax PF-611 and PF-814. Alternatively, suitable branched or coupled polypropylene can be prepared by means within the skill in the art such as by peroxide or electron-beam treatment, for instance as disclosed by DeNicola et al. in U.S. Pat. No. 5,414,027 (the use of high energy (ionizing) radiation in a reduced oxygen atmosphere); EP 0 190 889 to Himont (electron beam irradiation of isotactic polypropylene at lower temperatures); U.S. Pat. No. 5,464,907 (Akzo Nobel NV); EP 0 754 711 Solvay (peroxide treatment); and U.S. patent application No. 09/133,576, filed Aug. 13, 1998 (azide coupling agents).

All references herein to elements or metals belonging to a certain Group refer to the Periodic Table of the Elements published and copyrighted by CRC Press, Inc., 1989. Also any reference to the Group or Groups shall be to the Group or Groups as reflected in this Periodic Table of the Elements using the IUPAC system for numbering groups.

Preparation of polypropylene polymers is well within the skill in the art. But advantageous catalysts for use in preparing narrow molecular weight distribution polypropylene polymers as well as preferred ethylene polymers useful in the practice of the invention are preferably derivatives of any transition metal including Lanthanides, but preferably of Group 3, 4, or Lanthanide metals which are in the +2, +3, or +4 formal oxidation state. Preferred compounds include metal complexes containing from 1 to 3 Π-bonded anionic or neutral ligand groups, which are optionally cyclic or non-cyclic delocalized Π-bonded anionic ligand groups. Exemplary of such Π-bonded anionic ligand groups are conjugated or nonconjugated, cyclic or non-cyclic dienyl groups, and allyl groups. By the term “Π-bonded” is meant that the ligand group is bonded to the transition metal by means of its delocalized Π-electrons.

Each atom in the delocalized Π-bonded group is optionally independently substituted with a radical selected from the group consisting of hydrogen, halogen, hydrocarbyl, halohydrocarbyl, hydrocarbyl-substituted metalloid radicals wherein the metalloid is selected from Group 14 of the Periodic Table of the Elements, and such hydrocarbyl- or hydrocarbyl-substituted metalloid radicals further substituted with a Group 15 or 16 hetero atom containing moiety. Included within the term “hydrocarbyl” are C₁-C₂₀ straight, branched and cyclic alkyl radicals, C₆-C₂₀ aromatic radicals, C₇-C₂₀ alkyl-substituted aromatic radicals, and C₇-C₂₀ aryl-substituted alkyl radicals. In addition two or more such adjacent radicals may together form a fused ring system, a hydrogenated fused ring system, or a metallocycle with the metal.

Suitable hydrocarbyl-substituted organometalloid radicals include mono-, di- and tri-substituted organometalloid radicals of Group 14 elements wherein each of the hydrocarbyl groups contains from 1 to 20 carbon atoms. Examples of advantageous hydrocarbyl-substituted organometalloid radicals include trimethylsilyl, triethylsilyl, ethyldimethylsilyl, methyldiethylsilyl, triphenylgermyl, and trimethylgermyl groups. Examples of Group 15 or 16 hetero atom containing moieties include amine, phosphine, ether or thioether moieties or monovalent derivatives thereof, e. g. amide, phosphide, ether or thioether groups bonded to the transition metal or Lanthanide metal, and bonded to the hydrocarbyl group or to the hydrocarbyl-substituted metalloid containing group.

Examples of advantageous anionic, delocalized Π-bonded groups include cyclopentadienyl, indenyl, fluorenyl, tetrahydroindenyl, tetrahydrofluorenyl, octahvdrofluorenyl, pentadienyl, cyclohexadienyl, dihvdroanthracenyl, hexahydroanthracenyl, and decahydroanthracenyl groups, as well as C₁-C₁₀ hydrocarbyl-substituted or C₁-C₁₀ hydrocarbyl-substituted silyl substituted derivatives thereof. Preferred anionic delocalized Π-bonded groups are cyclopentaclienyl, pentamethylcyclopentadienyl, tetramethylcyclopentadienvi, tetramethylsilvlcyclopentadienyl, indenyl, 2,3dimethylindenyl, fluorenyl, 2-methylindenvi, 2-methyl-4-phenytindenyl, tetrahydrofluorenvi, octahvdrofluorenyl, and tetrahydroindenyl.

A preferred class of catalysts are transition metal complexes corresponding to the Formula A:

LₗMXₘX′ₙX″ₚ, or a dimer thereof

wherein:

L is an anionic, delocalized, Π-bonded group that is bound to M, containing up to 50 non-hydrogen atoms, optionally two L groups may be joined together forming a bridged structure, and further optionally one L is bound to X;

M is a metal of Group 4 of the Periodic Table of the Elements in the +2, +3 or +4 formal oxidation state;

X is an optional, divalent substituent of up to 50 non-hydrogen atoms that together with L forms a metallocycle with M;

X′ at each occurrence is an optional neutral Lewis base having up to 20 non-hydrogen atoms and optionally one X′ and one L may be joined together;

X″ each occurrence is a monovalent, anionic moiety having up to 40 non-hydrogen atoms, optionally, two X″ groups are covalently bound together forming a divalent dianionic moiety having both valences bound to M, or, optionally two X″ groups are covalently bound together to form a neutral, conjugated or nonconjugated diene that is Π-bonded to M (whereupon M is in the +2 oxidation state), or further optionally one or more X″ and one or more X′ groups are bonded together thereby forming a moiety that is both covalently bound to M and coordinated thereto by means of Lewis base functionality;

l is 0, 1 or 2;

m is 0 or 1;

n is a number from 0 to 3;

p is an integer from 0 to 3. and

the sum, l+m+p, is equal to the formal oxidation state of M, except when two X″ groups together form a neutral conjugated or non-conjugated diene that is Π-bonded to M, in which case the sum l+m is equal to the formal oxidation state of M.

Preferred complexes include those containing either one or two L groups. The latter complexes include those containing a bridging group linking the two L groups. Preferred bridging groups are those corresponding to the formula (ER*₂)ₓ wherein E is silicon, germanium, tin, or carbon, R* independently each occurrence is hydrogen or a group selected from silyl, hydrocarbyl, hydrocarbyloxy and combinations thereof, said R* having up to 30 carbon or silicon atoms, and x is 1 to 8. Preferably, R* independently each occurrence is methyl, ethyl, propyl, benzyl, tert-butyl, phenyl, methoxy, ethoxy or phenoxy.

Examples of the complexes containing two L groups are compounds corresponding to the formula:

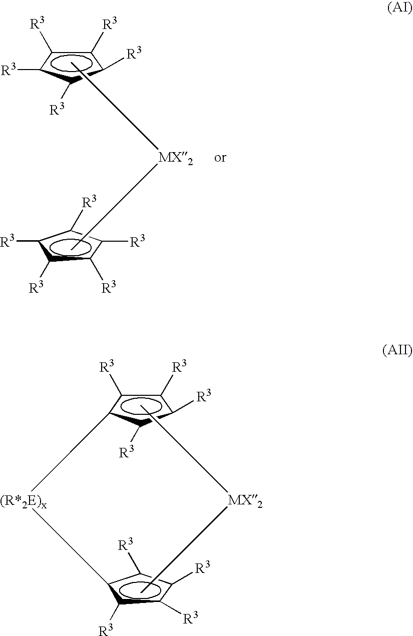

wherein:

M is titanium, zirconium or hafnium, preferably zirconium or hafnium, in the +2 or +4 formal oxidation state;

R³ in each occurrence independently is selected from the group consisting of hydrogen, hydrocarbyl, silyl, germyl, cyano, halo and combinations thereof, said R³ having up to 20 non-hydrogen atoms, or adjacent R³ groups together form a divalent derivative (for example, a hydrocarbadiyl, germadiyl group) thereby forming a fused ring system, and V independently each occurrence is an anionic ligand group of up to 40 non-hydrogen atoms, or two X″ groups together form a divalent anionic ligand group of up to 40 non-hydrogen atoms or together are a conjugated diene having from 4 to 30 non-hydrogen atoms forming □-complex with M, whereupon M is in the +2 formal oxidation state, and R*, E and x are as previously defined.

The foregoing metal complexes are especially suited for the preparation of polymers having stereoregular molecular structure. In such capacity it is preferred that the complex possesses Cₛ symmetry or possesses a chiral, stereorigid structure. Examples of the first type are compounds possessing different delocalized π-bonded systems, such as one cyclopentadienyl group and one fluorenyl group. Similar systems based on Ti(IV) or Zr(IV) were disclosed for preparation of syndiotactic olefin polymers in Ewen, et al., J. Am. Chem. Soc., 110, pp. 6255-6256 (1980). Examples of chiral structures include rac bis-indenyl complexes. Similar systems based on Ti(IV) or Zr(IV) were disclosed for preparation of isotactic olefin polymers in Wild et al., J. Organomet. Chem., 232, pp. 233-47, (1982).

Suitable bridged ligands containing two π-bonded groups are: (dimethylsilyl-bis(cyclopentadienyl)), (dimethylsilyl-bis(methylcyclopentadienyl)), (dimethylsilyl-bis(ethylcyclopentadienyl)), (dimethylsilyl-bis(t-butylcyclopentadienyl)), (dimethylsilyl-bis(tetramethylcyclopentadienyl)), (dimethylsilyl-bis(indenyl)), (dimethylsilyl-bis(tetrahydroindenyl)), (dimethylsilyl-bis(fluorenyl)), (dimethylsilyl-bis(tetrahydrofluorenyl)), (dimethylsilyl-bis(2-methyl-4-phenylindenyl)), (dimethylsilyl-bis(2-methylindenyl)), (dimethylsilyl-cyclopentadienyl-fluorenyl), (dimethylsilyl-cyclopentadienyl-octahydrofluorenyl), (dimethylsilyl-cyclopentadienyl-tetrahydrofluorenyl), (1,1,2,2-tetramethyl-1,2-disilyl-bis-cyclopentadienyl), (1,2-bis(cyclopentadienyl)ethane, and (isopropylidene-cyclopentadienyl-fluorenyl).

Preferred X″ groups are selected from hydride, hydrocarbyl, silyl, germyl, halohydrocarbyl, halosilyl, silylhydrocarbyl and aminohydrocarbyl groups, or two X″ groups together form a divalent derivative of a conjugated diene or else together they form a neutral, π-bonded, conjugated diene. Most preferred X″ groups are C₁-C₂₀ hydrocarbyl groups, including those optionally formed from two X″ groups together.

A further class of metal complexes corresponds to the preceding formula LₗMXₘX′ₙX″ₚ, or a dimer thereof, wherein X is a divalent substituent of up to 50 non-hydrogen atoms that together with L forms a metallocycle with M.

Preferred divalent X substituents include groups containing up to 30 non-hydrogen atoms comprising at least one atom that is oxygen, sulfur, boron or a member of Group 14 of the Periodic Table of the Elements directly attached to the delocalized π-bonded group, and a different atom, selected from the group consisting of nitrogen, phosphorus, oxygen or sulfur that is covalently bonded to M.

A preferred class of such Group 4 metal coordination complexes corresponds to the formula:

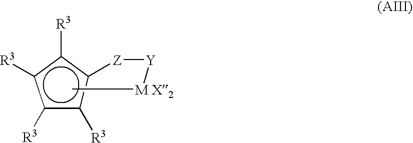

wherein:

M is titanium, zirconium or hafnium in the +2, +3 or +4 formal oxidation state;

X″ and R³ are as previously defined for formulas AI and AII;

Y is —O—, —S—, —NR*—, —NR*₂—, or —PR*—; and

Z is SiR*₂, CR*₂, SiR*₂SiR*₂, CR*₂CR*₂, CR*═CR*, CR*₂SiR*₂, or GeR*₂, wherein R* is as previously defined.

Illustrative Group 4 metal complexes that are optionally used as catalysts include: cyclopentadienyltitaniumtrimethyl, cyclopentadienyltitaniumtriethyl, cyclopentadienyltitaniumtriisopropyl, cyclopentadienyltitaniumtriphenyl, cyclopentadienyltitaniumtribenzyl, cyclopentadienyltitanium-2,4-dimethylpentadienyl, cyclopentadienyltitanium-2,4-dimethvlpentadienyltriethylphosphine, cyclopentadienyltitanium-2,4-dimethvlpentadienyltrimethylphosphine, cyclopentadienyltitaniumdimethylmethoxide, cyclopentadienyltitaniumdimethylchloride, pentamethylcyclopentadienyltitaniumtrimethyl, indenyltitaniumtrimethyl, indenyltitaniumtriethyl, indenyltitaniumtripropyl, indenyltitaniumtriphenyl, tetrahydroindenyltitaniumtribenzyl, pentamethylcyclopentadienyltitaniumtriisopropyl, pentamethylcyclopentadienyltitaniumtribenzyl, pentamethylcyclopentadienyltitaniumdimethylmethoxide, pentamethylcyclopentadienyltitaniumdimethylchloride, bis(η5-2,4-dimethylpentadienyl) titanium, bis(η5-2,4-dimethylpentadienyl)titaniumtrimethylphosphine, bis(η5-2,4-dimethylpentadienyl)titaniumtriethylphosphine, octahydrofluorenyltitaniumtrimethyl, tetrahydroindenyltitaniumtrimethyl, tetrahydrofluorenyltitaniumtrimethyl, (tert-butylamido)(1,1-dimethyl-2,3,4,9,10—1,4,η5,6,7,8-hexahydronaphthalenyl)dimethylsilanetitaniumdimethyl, (tert-butylamido)(1,1,2,3-tetramethyl-2,3,4,9,10—1,4,5,6,7,8-hexahydronaphthalenyl)dlmethylsilanetitaniumdimethyl, (tert-butylamido)(tetramethyl-η5-cyclopentadienyl) dimethylsilanetitanium dibenzyl, (tert-butylamido)(tetramethyl-η5-cyclopentadienyl)dimethylsilanetitanium dimethyl, (tert-butylamido)(tetramethyl-η5-cyclopentadienyl)-1,2-ethanediyltitanium dimethyl, (tert-butylamido)(tetramethyl-η5-indenyl)dimethylsilanetitanium dimethyl, (tert-butylamido)(tetramethyl-η5- cyclopentadienyl)dimethylsilane titanium (III) 2-(dimethylamino)benzyl; (tert-butylamido)(tetramethyl-η5-cyclopentadienyl)dimethylsilanetitanium (III) allyl, (tert-butylamido)(tetramethyl-η5-cyclopentadienyl)dimethylsilanetitanium (III) 2,4-dimethylpentadienyl, (tert-butylamido)(tetramethyl-η5-cyclopentadienyl)dimethyl-silanetitanium (II) 1,4-diphenyl-1,3-butadiene, (tert-butylamido)(tetramethyl-η5-cyclopentadienyl) dimethyl-silanetitanium (II) 1,3-pentadiene, (tert-butylamido)(2-methylindenyl)dimethylsilanetitanium (II) 1,4-diphenyl-1,3-butadiene, (tert-butylamido)(2-methylindenyl)dimethylsilanetitanium (II) 2,4-hexadiene, (tert-butylamido)(2-methylindenyl)dimethylsilanetitanium (IV) 2,3-dimethyl-1,3-butadiene, (tert-butylamido)(2-methylindenyl)dimethylsilanetitanium (IV)isoprene, (tert-butylamido)(2-methylindenyl)dimethylsilanetitanium 1,3-butadiene, (tert-butylamido)(2,3-dimethylindenyl)dimethylsilanetitanium (IV) 2,3-dimethyl-1,3-butadiene, (tert-butylamido)(2,3-dimethylindenyl)dimethylsilanetitanium (IV) isoprene; (tert-butylamido)(2,3-dimethylindenyl)dimethylsilanetitanium (IV) dimethyl; (tert-butylamido)(2,3-dimethylindenyl)dimethylsilanetitanium (IV) dibenzyl; (tert-butylamido)(2,3-dimethylindenyl)dimethylsilanetitanium 1,3-butadiene,(tert-butylamido)(2,3-dimethylindenyl)dimethylsilanetitanium (11) 1,3-pentadiene, (tertbutylamido)(2,3-dimethylindenyl)dimethylsilanetitanium (11) 1,4-diphenyl-1,3butadiene, (tert-butylamido)(2-methylindenyl)dimethylsilanetitanium (11) 1,3pentadiene,(tert-butylamido)(2-methylindenyl)dimethylsilanetitanium (IV) dimethyl, (tert-butylamido)(2-methylindenyl)dimethylsilanetitanium (IV) dibenzyl, (tert-butylamido)(2-methyl-4-phenylindenvl)dimethylsilanetitanium (II)1,4-diphenyl-1,3-butadiene, (tert-butylamido)(2-methyl-4-phenylindenyl)dimethylsilanetitanium (II) 1,3-pentadiene, (tert-butylamido)(2-methyl-4-phenylindenyl)dimethylsilanetitanium (II) 2,4-hexadiene, (tert-butylamido)(tetramethyl-η5-cyclopentadienyl)dimethyl-silanetitanium 1,3-butadiene, (tert-butylamido)(tetramethyl-il5-cyclopentadienyl)dimethyl-silanetitanium (IV) 2,3-dimethyl-1,3-butadiene, (tert-butylamido)(tetramethyl-η5-cyclopentadienyl)dimethyl-silanetitanium (IV) isoprene, (tert-butylamido)(tetramethyl-η5-cyclopentadienyl)dimethyl-silanetitanium (II) 1,4-dibenzyl-1,3-butadiene, (tert-butylamido)(tetramethyl-, η5-cyclopentadienyl)dimethyl-silanetitanium (II) 2,4- hexadiene, (tert-butylamido)(tetramethyl-η5-cyclopentadienyl)dimethyl-silanetitanium (II) 3-methyl-1,3-pentadiene, (tert-butylamido)(2,4-dimethylpentadien-3-yl)dimethyl-silanetitaniumclimethyl, (tert-butylamido)(6,6dimethylcyclohexadienyl)dimethyl-silanetitaniumdimethyl, (tert-butylamido)(1,1-dimethyl-2,3,4,9,10,1,4,5,6,7,8-hexahydronaphthalen-4-yl)dimethylsilanetitaniumdimethyl, (tert-butylamido)(1,1,2,3-tetramethyl-2,3,4,9,10,1,4,5,6,7,8-hexahydronaphthalen-4-yl) dimethylsilanetitaniumdimethyl(tert-butylamido)(tetramethyl-η5-cyclopentadienyl methylphenyl-silanetitanium (IV) dimethyl, (tert-butylamido)(tetramethyl-η5-cyclopentadienyl methylphenyl-silanetitanium (II) 1,4-diphenyl-1,3-butadiene, 1-(tert-butylamido)-2-(tetramethyl-η5-cyclopentadienyl)ethanediyl-titanium (IV) dimethyl, and 1-(tert-butylamido)-2-(tetramethyl-η5-cyclopentadienyl)ethanediyl- titanium (II)1,4-diphenyl-1,3-butadiene.

Complexes containing two L groups including bridged complexes include: bis(cyclopentadienyl)zirconiumdimethyl, bis(cyclopentadienyl)zirconium dibenzyl, bis (cyclopentadienyl) zirconium methyl benzyl, bis (cyclopentadienyl) zirconiummethyl phenyl, bis(cyclopentadienyl)zirconiumdiphenyl, bis(cyclopentadienyl)titanium-allyl, bis(cyclopentadienyl)zirconiummethylmethoxide, bis(cyclopentadienyl) zirconiummethylchloride, bis(pentamethylcyclopentadienyl) zirconiumdime thyl, bis (pentamethylcyclopentadienyl) titaniumdimethyl, bis(indenyl)zirconiumdlmethyl, bis(indenyl)zirconiummethyl (2-(dimethylamino)benzyl), bis (indenyl) zirconium methyltrimethylsilyl, bis(tetrahvdroindenvl)zirconium methyltrimethylsilyl, bis (pentamethylcyclopentadienyl) zirconiummethyl benzyl, bis(pentamethylcyclopentadienyl)zirconiumdibenzyl, bis(pentamethylcycl o pentad ienvl) zirconiummethylmethoxide, bis(pentamethylcvclopentadienyl)zirconiummethvylchloride, bis(methylethylcyclopentadienyl)zirconiumdimethyl, bis(butylcyclopentadienyl) zirconium dibenzyl, bis(t-butylcyclopentadienyl)zirconiumdimethyl, bis(ethyltetramethylcyclopentadienyl) zirconiumdimethyl, bis(methylpropylcyclo pentadienyl) zirconium dibenzyl, bis(trimethylsilylcyclopentadienyl)zirconium dibenzyl, dimethylsilyl-bis(cyclopentadienyl)zirconiumdimethyl, dimethylsilyl-bis(tetramethylcyclopentadienyi)titanium-(III)allyl dimethylsllyl-bis(t-butylcyclopentadienyl)zirconiumdichloride, dimethylsllyl-bis(n-butylcyclopentadienyl)zirconiumdichloride, (methylene-bis(tetramethylcyclopentadienvl)titanium(III) 2-(dimethylamino)benzyl, (methylene-bis(n-butylcyclopentadienyl)titanium(III) 2-(dimethylamino)benzyl, dimethylsilyl-bis(indenyl)zirconiumbenzylchloride, dimethylsilyl-bis(2-methylindenyl)zirconiumdimethyl, dimethylsilyl-bis(2-methyl-4-phenylindenyl)zirconiumdimethyl, dimethylsilyl-bis(2-methylindenyl)zirconium-1,4-diphenyl-1,3-butadiene, dimethylsilyl-bis(2-methyl-4-phenylindenyl) zirconium (II) 1,4-diphenyl-1,3-butadiene, dimethylsilyl-bis(tetrahydroindenyl)zlrconium(II) 1,4-diphenyl-1,3-butadiene, dimethylsilyl-bis(fluorenyl)zirconiummethylchloride, dimethylsilyl-bis (tetrahydrofluorenyl) zirconium bis(trimethylsilyl), and dimethylsilyl (tetramethylcyclopentadienyl) (fluorenyl) zirconium dimethyl.

Other catalysts, especially catalysts containing other Group 4 metals, will, of course, be apparent to those skilled in the art.

Preferred metallocene species include constrained geometry metal complexes, including titanium complexes, and methods for their preparation as are disclosed in U.S. application Ser. No. 545,403, filed Jul. 3, 1990 (EP-A-416,815); U.S. application Ser. No. 967,365, filed Oct. 28, 1992 (EP-A-514,828); and U.S. application Ser. No. 876,268, filed May 1, 1992, (EP-A-520,732), as well as U.S. Pat. No. 5,055,438; U.S. Pat. No. 5,057,475; U.S. Pat. No. 5,096,867; U.S. Pat. No. 5,064,802; U.S. Pat. No. 5,096,867; U.S. Pat. No. 5,132,380; U.S. Pat. No. 5,132,380; U.S. Pat. No. 5,470,993; U.S. Pat. No. 5,486,632; U.S. Pat. No. 5,132,380; and U.S. Pat. No. 5,321,106.

The most preferred constrained geometry complexes for manufacturing preferred narrow molecular weight distribution polypropylene polymers, substantially linear ethylene polymer and substantially random ethylene/vinyl aromatic interpolymer for use in the invention are those in which the diene is associated with the metal as a □-complex, the metal is in the +2 formal oxidation state, and the diene normally assumes an s-trans configuration or an s-cis configuration in which the bond lengths between the metal and the four carbon atoms of the conjugated diene are nearly equal. The dienes of complexes wherein the metal is in the +2 formal oxidation state are coordinated via □-complexation through the diene double bonds and not through a metallocycle resonance form containing □-bonds. The nature of the bond is readily determined by X-ray crystallography or by NMR spectral characterization according to the techniques of Yasuda, et al., Organometallics, 1, 388 (1982), (Yasuda I); Yasuda, et al. Acc. Chem. Res., 18, 120 (1985), (Yasuda II); Erker, et al., Adv. Organomet. Chem., 24, 1 (1985)(Erker, et al. (I)); and U.S. Pat. No. 5,198,401. By the term “□-complex” is meant both the donation and back acceptance of electron density by the ligand are accomplished using ligand □-orbitals. Such dienes are referred to as being □-bound. It is to be understood that the present complexes may be formed and utilized as mixtures of the □-complexed and □-complexed diene compounds.

The formation of the diene complex in either the □ □ or □ □ state depends on the choice of the diene, the specific metal complex and the reaction conditions employed in the preparation of the complex. Generally, terminally substituted dienes favor formation of □-complexes and internally substituted dienes favor formation of □-complexes. Especially useful dienes for such complexes are compounds that do not decompose under reaction conditions used to prepare the complexes of the invention. Under subsequent polymerization conditions, or in the formation of catalytic derivatives of the present complexes, the diene group may undergo chemical reactions or be replaced by another ligand.

Examples of suitable neutral dienes used to prepare □ □ bonded diene containing metal complexes include: 1,3-pentadiene, 2,4-hexadiene, 1,4-diphenyl-1,3-butadiene, 3-methyl-1,3-pentadiene, 1,4-dibenzyl-1,3-butadiene, 1,4-ditolyl-1,3-butadiene, and 1,4-bis(trimethylsilyl)-1,3-butadiene. Most preferred neutral diene groups are 1,3-pentadiene, 2,4-hexadiene and 1,4-diphenyl-1,3-butadiene.

Accordingly, the most preferred embodiments of the invention utilizes a metal complex containing one and only one cyclic delocalized n-bonded, anionic, group, characterized in that it corresponds to the formula:

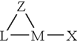

wherein:

M is titanium or zirconium in the +2 formal oxidation state;

L is a group containing a cyclic, delocalized, anionic, π-system through which the group is bound to M, and which group is also bound to Z;

Z is a moiety bound to M via a σ-bond, comprising boron, or a member of Group 14 of the Periodic Table of the Elements, and also comprising nitrogen, phosphorus, sulfur or oxygen, said moiety having up to 60 non-hydrogen atoms; and

X is a neutral, conjugated or nonconjugated diene, optionally substituted with one or more hydrocarbyl groups, said X having up to 40 carbon atoms and forming a π-complex with M.

In a more preferred embodiment, the metal complex is characterized in that it corresponds to the formula:

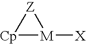

wherein:

Z, M and X are as defined in claim 1, and

Cp is a C₅H₄ group bound to Z and bound in an η⁵ bonding mode to M or is such an η⁵ bound group substituted with from one to four substituents independently selected from hydrocarbyl, silyl, germyl, halo, cyano, and combinations thereof, said substituent having up to 20 nonhydrogen atoms, and optionally, two such substituents (except cyano or halo) together cause Cp to have a fused ring structure.

Even more preferably the metal complex is characterized in that it corresponds to the formula:

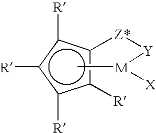

wherein R′ each occurrence is independently selected from hydrogen, hydrocarbyl, silyl, germyl, cyano, halo and combinations thereof, said R′ having up to 20 non-hydrogen atoms, and optionally two R′ groups (when R′ is not hydrogen, halo or cyano) together form a divalent derivative thereof connected to adjacent positions of the cyclopentadienyl ring to form a fused ring structure;

X is a neutral η⁴-bonded diene group having up to 30 non-hydrogen atoms, which forms a π-complex with M;

Y is —O—, —S—, —NR*—, —PR*—;

M is titanium or zirconium in the +2 formal oxidation state;

Z* is SiR*₂, CR*₂, SiR*₂SiR*₂, CR*₂CR*₂, CR*═CR*, CR*₂SiR*₂, or GeR*₂; wherein:

R* each occurrence is independently hydrogen, or a member selected from hydrocarbyl, silyl, halogenated alkyl, halogenated aryl, and combinations thereof, said R* having up to 10 non-hydrogen atoms, and optionally, two R* groups from Z*, or an R* group from Z* and an R* group from Y (when R* is not hydrogen) form a ring system.

For this even more preferred metal complex, it is preferable that at least one of R′ or R* is an electron donating moiety or Y is a nitrogen or phosphorus containing group corresponding to the formula —N(R′)— or —P(R″)—, wherein R″ is C₁-C₁₀ hydrocarbyl.

For the even more preferred complex where Y is a nitrogen or phosphorus containing group corresponding to the formula —N(R″)— or —P(R″)—, wherein R″ is C₁-C₁₀ hydrocarbyl is it preferred that the complex is characterized in that it corresponds to the formula:

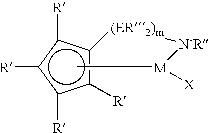

wherein:

M is titanium in the +2 formal oxidation state;

X is s-trans-η⁴-1,4-diphenyl-1,3-butadiene; s-trans-η⁴-3-methyl-1,3-pentadiene; s-trans-η⁴-1,4-dibenzyl-1,3-butadiene; s-trans-η⁴-2,4-hexadiene; s-trans-η⁴-1,3-pentadiene; s-trans-η⁴-1,4-ditolyl-1,3-butadiene; s-trans-η⁴-1,4-bis(trimethylsilyl)-1,3-butadiene; s-cis-η⁴-1,4-diphenyl-1,3-butadiene; s-cis-η⁴-3-methyl-1,3-pentadiene; s-cis-η⁴-1,4-dibenzyl-1,3-butadiene; s-cis-η⁴-2,4-hexadiene; s-cis-η⁴-1,3-pentadiene; s-cis-η⁴-1,4-ditolyl-1,3-butadiene; or s-cis-η⁴-1,4-bis(trimethylsilyl)-1,3-butadiene, said s-cis isomers forming a π-bound diene complex;

R′ each occurrence is independently selected from the group consisting of hydrogen, silyl, hydrocarbyl and combinations thereof said R′ having up to 10 carbon or silicon atoms, and optionally two such R′ groups (when R′ is not hydrogen) together form a divalent derivative thereof connected to adjacent positions of the cyclopentadienyl ring to form a fused ring structure;

R″ is C₁₋₁₀ hydrocarbyl;

R′″ independently each occurrence is hydrogen or C₁-C₁₀ hydrocarbyl;

E is independently each occurrence silicon or carbon; and

m is 1 or 2.

In other preferred embodiments, R″ is methyl, ethyl, propyl, butyl, pentyl, hexyl, norbomyl, benzyl, or phenyl; and the cyclopentadienyl group is cyclopentadienyl, tetramethylcyclopentadienyl, indenyl, tetrahydroindenyl, fluorenyl, tetrahydrofluorenyl or octahydrofluorenyl.

In other preferred embodiments, M is titanium in the +2 formal oxidation state.

In still certain other preferred embodiments, the most preferred metal complex is (tert-butylamido)(tetramethyl-η⁵-cyclopentadienyl)dimethylsilanetitanium(II) s-trans-η⁴-3-methyl-1,3-pentadiene; (tert-butylamido)(tetramethyl-η⁵-cyclopentadienyl)-dimethylsilanetitanium(II) s-trans-η⁴-1,3-pentadiene; (tert-butylamido)(tetramethyl-η⁵-cyclopentadienyl)-dimethylsilanetitanium(II) s-trans-η⁴-2,4-hexadiene; (tert-butylamido)(tetramethyl-η5-cyclopentadienyl)dimethylsilanetitanium(II) s-trans-η⁴-1,4-bis(trimethylsilyl)-1,3-butadiene; (tert-butylamido)-(tetramethyl-η⁵-cyclopentadienyl)dimethylsilanetitanium(II) s-trans-η⁴-trans, trans-1,4-diphenyl-1,3-butadiene; (tert-butylamido)(tetramethyl-η⁵-cyclopentadienyl)dimethylsilanetitanium(II) s-cis-η⁴-3-methyl-1,3-pentadiene; (tert-butylamido)(tetramethyl-η⁵-cyclopentadienyl)-dimethylsilanetitanium(II) s-cis-η⁴-1,3-pentadiene; (tert-butylamido)(tetramethyl-η⁵-cyclopentadienyl)-dimethylsilanetitanium(II) s-cis-η⁴-2,4-hexadiene; (tert-butylamido)(tetramethyl-η⁵-cyclopentadienyl)dimethylsilanctitanium(II) s-cis-η⁴-1,4-bis(trimethylsilyl)-1,3-butadiene; or (tert-butylamido)-(tetramethyl-η⁵-cyclopentadienyl)dimethylsilanetitanium(II) s-cis-η⁴-trans, trans-1,4-diphenyl-1,3-butadiene, said s-cis isomers forming a π-bound diene complex.

Metallocene catalysts are advantageously rendered catalytically active by combination with one or more activating cocatalysts, by use of an activating technique, or a combination thereof. Advantageous cocatalysts are those boron-containing cocatalysts within the skill in the art. Among the boron-containing cocatalysts are tri(hydrocarbyl)boron compounds and halogenated derivatives thereof, advantageously having from 1 to 10 carbons in each hydrocarbyl or halogenated hydrocarbyl group, more especially perfluorinated tri(aryl)boron compounds, and most especially tris(pentafluorophenyl)borane), amine, phosphine, aliphatic alcohol and mercaptan adducts of halogenated tri(C₁-C₁₀ hydrocarbyl)boron compounds, especially such adducts of perfluorinated tri(aryl)boron compounds. Alternatively, the cocatalyst includes borates such as tetrapheny Borate having as counterions ammonium ions such as are within the skill in the art as illustrated by European Patent EP 672,688 (Canich, Exxon), published Sep. 20, 1995.

The cocatalyst can be used in combination with a tri(hydrocarbyl)aluminum compound having from 1 to 10 carbons in each hydrocarbyl group or an oligomeric or polymeric alumoxane. It is possible to employ these aluminum compounds for their beneficial ability to scavenge impurities such as oxygen, water, and aldehydes from the polymerization mixture. Preferred aluminum compounds include trialkyl aluminum compounds having from 2 to 6 carbons in each alkyl group, especially those wherein the alkyl groups are ethyl, propyl, isopropyl, n-butyl, isobutyl, pentyl, neopentyl, or isopentyl, and methylalumoxane, modified by methylalumoxane (that is methylalumoxane modified by reaction with triisobutyl aluminum) (MMAO) and diisobutylalumoxane. The molar ratio of aluminum compound to metal complex is preferably from 1:10,000 to 1000:1, more preferably from 1:5000 to 100:1, most preferably from 1:100 to 100:1.

Cocatalysts; are used in amounts and under conditions within the skill in the art. Their use is applicable to all processes within the skill in the art, including solution, slurry, bulk (especially propylene), and gas phase polymerization processed. Such processes include those fully disclosed in the references cited previously.

The molar ratio of catalyst/cocatalyst or activator employed preferably ranges from 1:10,000 to 100:1, more preferably from 1:5000 to 10:1, most preferably from 1:1000 to 1:1.

When utilizing such strong Lewis acid cocatalysts to polymerize higher (□-olefins, especially propylene, it has been found especially desirable to also contact the catalyst/cocatalyst mixture with a small quantity of ethylene or hydrogen (preferably at least one mole of ethylene or hydrogen per mole of metal complex, suitably from 1 to 100,000 moles of ethylene or hydrogen per mole of metal complex). This contacting may occur before, after or simultaneously to contacting with the higher □-olefin. If the foregoing Lewis acid activated catalyst compositions are not treated in the foregoing manner, either extremely long induction periods are encountered or no polymerization at all results. The ethylene or hydrogen may be used in a suitably small quantity such that no significant affect on polymer properties is observed.

In most instances, the polymerization advantageously takes place at conditions known in the prior art for Ziegler-Natta or Kaminsky-Sinn type polymerization reactions, that is, temperatures from 0-250° C. and pressures from atmospheric to 3000 atmospheres. Suspension, solution, slurry, gas phase or high pressure, whether employed in batch or continuous form or under other process conditions, including the recycling of condensed monomers or solvent, may be employed if desired. Examples of such processes are well known in the art for example, WO 88/02009-A1 or U.S. Pat. No. 5,084,534 disclose conditions that are advantageously employed with the polymerization catalysts. A support, especially silica, alumina, or a polymer (especially polytetrafluoroethylene or a polyolefin) is optionally employed, and desirably is employed when the catalysts are used in a gas phase polymerization process. Such supported catalysts are advantageously not affected by the presence of liquid aliphatic or aromatic hydrocarbons such as are optionally present under the use of condensation techniques in a gas phase polymerization process. Methods for the preparation of supported catalysts are disclosed in numerous references, examples of which are U.S. Pat. Nos. 4,808,561; 4,912,075; 5,008,228; 4,914,253; and 5,086,025 and are suitable for the preparation of supported catalysts.

In such a process the reactants and catalysts are optionally added to the solvent sequentially, in any order, or alternatively one or more of the reactants or catalyst system components are premixed with solvent or material preferably miscible therewith then mixed together or into more solvent optionally containing the other reactants or catalysts. The preferred process parameters are dependent on the monomers used and the polymer desired.

Propylene is added to the reaction vessel in predetermined amounts to achieve predetermined per ratios, advantageously in gaseous form using a joint mass flow controller. Alternatively propylene or other liquid monomers are added to the reaction vessel in amounts predetermined to result in ratios desired in the final product. They are optionally added together with the solvent (if any), alpha-olefin and functional comonomer, or alternatively added separately. The pressure in the reactor is a function of the temperature of the reaction mixture and the relative amounts of propylene or other monomers used in the reaction. Advantageously, the polymerization process is carried out at a pressure of from 10 to 1000 psi (70 to 7000 kPa), most preferably from 140 to 550 psi (980 to 3790 kPa). The polymerization is then conducted at a temperature of from 25 to 200° C., preferably from 50 to 100° C., and most preferably from 60 to 80° C.

The process is advantageously continuous, in which case the reactants are added continuously or at intervals and the catalyst and, optionally cocatalyst, are added as needed to maintain reaction or make up loss or both.

Solution polymerization or bulk polymerization is preferred. In the latter case liquid polypropylene is the reaction medium. Preferred solvents include mineral oils and the various hydrocarbons which are liquid at reaction temperatures. Illustrative examples of useful solvents include straight- and branched-chain hydrocarbons such as alkanes, for example, isobutane, butane, pentane, isopentene, hexane, heptane, octane and nonane, as well as mixtures of alkanes including kerosene and Isopar E, available from Exxon Chemicals Inc.; cyclic and alicyclic hydrocarbons such as cyclopentane, cyclohexane, methylcyclohexane, methylcycloheptane, and mixtures thereof, and aromatics and alkyl-substituted aromatic compounds such as benzene, toluene, xylenes, ethylbenzene, and diethylbenzene and perfluorinated hydrocarbons such as perfluorinated C₄-C₁₀ alkanes. Suitable solvents may include liquid olefins which may act as monomers or comonomers. Mixtures of the foregoing are also suitable.

At all times, the individual ingredients as well as the recovered catalyst components are protected from oxygen and moisture. Therefore, the catalyst components and catalysts are prepared and recovered in an oxygen- and moisture-free atmosphere. Preferably, therefore, the reactions are performed in the presence of a dry, inert gas such as, for example, nitrogen.

Without limiting in any way the scope of the invention, one means for carrying out such a polymerization process is as follows. In a stirred-tank reactor, olefin monomer is introduced continuously together with solvent and propylene monomer. The reactor contains a liquid phase composed substantially of monomers together with any solvent or additional diluent. Catalyst and cocatalyst are continuously introduced in the reactor liquid phase. The reactor temperature and pressure may be controlled by adjusting the solvent/monomer ratio, the catalyst addition rate, as well as by cooling or heating coils, jackets or both. The polymerization rate is controlled by the rate of catalyst addition. The polymer product molecular weight is controlled, optionally, by controlling other polymerization variables such as the temperature, monomer concentration, or by a stream of hydrogen introduced to the reactor, as is well known in the art. The reactor effluent is contacted with a catalyst kill agent such as water or an alcohol. The polymer solution is optionally heated, and the polymer product is recovered by flashing off gaseous monomers as well as residual solvent or diluent at reduced pressure, and, if necessary, conducting further devolatilization in equipment such as a devolatilizing extruder. In a continuous process, the mean residence time of the catalyst and polymer in the reactor generally is from 5 minutes to 8 hours, and preferably from 10 minutes to 6 hours.

Preferably, the polymerization is conducted in a continuous solution polymerization system, optionally comprising more than one reactor connected in series or parallel.

The ethylene polymer used in the polymer blend composition to make the fiber and fabric of the present invention is generally characterized as having a high molecular weight. Preferably, the ethylene polymer is an ethylene/x-olefin interpolymer having an I₂ melt index (ASTM 1238 Condition 190° C./2.2 kg) in the range of from 0.1 to 100 g/10 minutes, more preferably in the range of from 0.5 to 10. Although the ethylene polymer can be a polyethylene homopolymer or interpolymer having a density up to 0.965 g/cc, preferably, the density of the ethylene polymer is less than or equal to 0.90 g/cm³, preferably less than or equal to 0.89 g/cm³, more preferably less than or equal to 0.88 g/cm³, and most preferably a deensity in the range of from 0.85 to 0.88 grams/cubic centimeter, as measured in accordance with ASTM D792.

Suitable ethylene polymers include, for example, high density polyethylene (HDPE), heterogeneously branched linear low density polyethylene (LLDPE), heterogeneously branched ultra low density polyethylene (ULDPE), homogeneously branched linear ethylene polymers, homogeneously branched substantially linear ethylene polymers, homogeneously branched long chain branched ethylene polymers, and ethylene vinyl or vinylidene aromatic monomer interpolymers. But homogeneously branched ethylene polymers and ethylene vinyl or vinylidene aromatic monomer interpolymers are preferred, and homogeneously branched substantially linear ethylene polymers and substantially random ethylene/vinyl aromatic interpolymers are most preferred.

The homogeneously branched substantially linear ethylene polymers used in the polymer blend compositions disclosed herein can be interpolymers of ethylene with at least one C₃-C₂₀ □-olefin. As described above, the terms “interpolymer” and “ethylene polymer” as used herein indicate that the polymer can be a copolymer, a terpolymer or any other polymer comprised or made from one or more monomers. Monomers usefully copolymerized with ethylene to make the homogeneously branched linear or substantially linear ethylene polymers include the C₃-C₂₀ □-olefins especially 1-pentene, 1-hexene, 4-methyl-1-pentene, 1-heptene and 1-octene. Especially preferred comonomers include I-pentene, I-hexene, 1-heptene and 1-octene. Copolymers of ethylene and a C₃-C₂₀ □-olefin are especially preferred.

The term “substantially linear” means that the polymer backbone is substituted with 0.01 long chain branches/1000 carbons to 3 long chain branches/1000 carbons, more preferably from 0.01 long chain branches/1000 carbons to I long chain branches/1000 carbons, and especially from 0.05 long chain branches/1000 carbons to 1 long chain branches/1000 carbons.

Long chain branching is defined herein as a branch having a chain length greater than that of any short chain branches which are a result of comonomer incorporation. The long chain branch can be as long as about the same length as the length of the polymer back-bone.

Long chain branching can be determined by using ¹³C nuclear magnetic resonance (NMR) spectroscopy and is quantified using the method of Randall (Rev. Macromol. Chem. Phvs., C29 (2&3), p. 275-287).

In the case of substantially linear ethylene polymers, such polymers can be characterized as having:

a) a melt flow ratio, I₁₀/I₂, ≧5.63,

b) a molecular weight distribution, M_{w}/Mₙ, defined by the equation:

Mw/Mn≦(I₁₀/I₂)−4.63, and

c) a critical shear stress at onset of gross melt fracture greater than 4×10⁶ dynes/cm² or a critical shear rate at onset of surface melt fracture at least 50 percent greater than the critical shear rate at the onset of surface melt fracture of either a homogeneously or heterogeneously branched linear ethylene polymer having about the same I₂ and M_{w}/Mₙ or both.

In contrast to substantially linear ethylene polymers, linear ethylene polymers lack long chain branching, that is, they have less than 0.01 long chain branches/1000 carbons. The term “linear ethylene polymers” thus does not refer to high pressure branched polyethylene, ethylene/vinyl acetate copolymers, or ethylene/vinyl alcohol copolymers which are known to those skilled in the art to have numerous long chain branches.

Linear ethylene polymers include, for example, the traditional heterogeneously branched linear low density polyethylene polymers or linear high density polyethylene polymers made using Ziegler polymerization processes (for example, U.S. Pat. No. 4,076,698 (Anderson et al.)), or homogeneous linear polymers (for example, U.S. Pat. No. 3,645,992 (Elston)).

Both the homogeneous linear and the substantially linear ethylene polymers used to form the fibers have homogeneous branching distributions. The term “homogeneously branching distribution” means that the comonomer is randomly distributed within a given molecule and that substantially all of the copolymer molecules have the same ethylene/comonomer ratio. The homogeneous ethylene/□-olefin polymers used in this invention essentially lack a measurable “high density” fraction as measured by the TREF technique (that is, the homogeneous branched ethylene/□-olefin polymers are characterized as typically having less than 15 weight percent, preferably less than 10 weight percent, and more preferably less than 5 weight percent of a polymer fraction with a degree of branching less than or equal to 2 methyls/1000 carbons).

The homogeneity of the branching distribution can be measured variously, including measuring the SCBDI (Short Chain Branch Distribution Index) or CDBI (Composition Distribution Branch Index). SCBDI or CDBI is defined as the weight percent of the polymer molecules having a comonomer content within 50 percent of the median total molar comonomer content. The CDBI of a polymer is readily calculated from data obtained from techniques known in the art, such as, for example, temperature rising elusion fractionation (abbreviated herein as “TREF)as described, for example, in Wild et al, Journal of Polymer Science, Poly. Phys. Ed., Vol. 20, p. 441 (1982), and U.S. Pat. No. 5,008,204 (Stehling). The technique for calculating CDBI is described in U.S. Pat. No. 5,322,728 (Davey et al.) and in U.S. Pat. No. 5,246,783 (Spenadel et al.). The SCBDI or CDBI for homogeneously branched linear and substantially linear ethylene polymers is typically greater than 50 percent, preferably greater than 60 percent, more preferably greater than 70 percent, and most preferably greater than 90 percent.

The homogeneous branched ethylene polymers used to make the fibers of the present invention will preferably have a single melting peak, as measured using differential scanning calorimetry (DSC) in the temperature range of −30° C. to 150° C., in contrast to conventional heterogeneously branched linear ethylene polymers, which have 2 or more melting peaks, due to the heterogeneously branched polymer's broad branching distribution.

Substantially linear ethylene polymers exhibit a highly unexpected flow property where the I₁₀/I₂ value of the polymer is essentially independent of polydispersity index (that is, M_{w}/Mₙ) of the polymer. This is contrasted with conventional homogeneous linear ethylene polymers and heterogeneously branched linear polyethylene resins for which one must increase the polydispersity index in order to increase the I₁₀/I₂ value. Substantially linear ethylene polymers also exhibit good processability and low pressure drop through a spinneret pack, even when using high shear filtration.

Homogeneous linear ethylene polymers useful to make the fibers and fabrics of the invention are a known class of polymers which have a linear polymer backbone, no long chain branching and a narrow molecular weight distribution. Such polymers are interpolymers of ethylene and at least one □-olefin comonomer of from 3 to 20 carbon atoms, and are preferably copolymers of ethylene with a C_{□}-C₂₀ □-olefin, and are most preferably copolymers of ethylene with propylene, 1-butene, 1-hexene, 4-methyl-1-pentene or 1-octene. This class of polymers is disclosed for example, by Elston in U.S. Pat. No. 3,645,992 and subsequent processes to produce such polymers using metallocene catalysts have been developed, as shown, for example, in EP 0 129 368, EP 0 260 999, U.S. Pat. No. 4,701,432; U.S. Pat. No. 4,937,301; U.S. Pat. No. 4,935,397; U.S. Pat. No. 5,055,438; and WO 90/07526 and others. The polymers can be made by conventional polymerization processes (for example, gas phase, slurry, solution, and high pressure).

Another measurement usefuil in characterizing the molecular weight of ethylene polymers is conveniently indicated using a melt index measurement according to ASTM D-1238, Condition 190° C./10 kg (formerly known as “Condition (N)” and also known as I₁₀). The ratio of these two melt index terms is the melt flow ratio and is designated as I₁₀/I₂. For the substantially linear ethylene polymers used polymer compositions useful in making the fibers of the invention, the I₁₀/I₂ ratio indicates the degree of long chain branching, that is, the higher the I₁₀/I₂ ratio, the more long chain branching in the polymer. The substantially linear ethylene polymers can have varying I₁₀/I₂ ratios, while maintaining a low molecular weight distribution (that is, M_{w}/Mₙ from 1.5 to 2.5). Generally, the I₁₀/I₂ ratio of the substantially linear ethylene polymers is at least 5.63, preferably at least 6, more preferably at least 7, and especially at least 8. Generally, the upper limit of I₁₀/I₂ ratio for the homogeneously branched substantially linear ethylene polymers is 50 or less, preferably 30 or less, and especially 20 or less.

Additives such as antioxidants (for example, hindered phenolics (for example, Irganox™1010 made by Ciba-Geigy Corp.), phosphites (for example, Irgafos™) 168 made by Ciba-Geigy Corp.), cling additives (for example, polyisobutylene (PIB)), antiblock additives, pigments, can also be included in the first polymer, the second polymer, or the overall polymer composition useful to make the fibers and fabrics of the invention, to the extent that they do not interfere with the enhanced fiber and fabric properties discovered by Applicants.

The molecular weight distributions of ethylene polymers are determined by gel permeation chromatography (GPC) on a Waters 150C high temperature chromatographic unit equipped with a differential refractometer and three columns of mixed porosity. The columns are supplied by Polymer Laboratories and are commonly packed with pore sizes of 10³, 10⁴, 10⁵ and 10⁶ Å. The solvent is 1,2,4-trichlorobenzene, from which 0.3 percent by weight solutions of the samples are prepared for injection. The flow rate is 1.0 milliliters/minute, unit operating temperature is 140° C. and the injection size is 100 microliters.

The molecular weight determination with respect to the polymer backbone is deduced by using narrow molecular weight distribution polystyrene standards (from Polymer Laboratories) in conjunction with their elution volumes. The equivalent polyethylene molecular weights are determined by using appropriate Mark-Houwink coefficients for polyethylene and polystyrene (as described by Williams and Ward in Journal of Polymer Science Polymer Letters, Vol. 6, p. 621, 1968) to derive the following equation:

M_{polyethylene}=a*(M_{polystyrene)}^{b}.

In this equation, a=0.4316 and b=1.0. Weight average molecular weight, Mw, is calculated in the usual manner according to the following formula: Mⱼ=(Σwᵢ(Mᵢ^{j}))^{j}; where wᵢ is the weight fraction of the molecules with molecular weight Mᵢ eluting from the GPC column in fraction i and j=1 when calculating _{Mw} and j=−1 when calculating Mₙ. The novel composition has M_{w}/Mₙ less than or equal to 3.3, preferably less than or equal to 3, and especially in the range of from 2.4 to 3.

The M_{w}/Mₙ of the substantially linear homogeneously branched ethylene polymers is defined by the equation:

M_{w}/Mₙ≦(I₁₀/I₂)−4.63

Preferably, the M_{w}/Mₙ for the ethylene polymers is from 1.5 to 2.5, and especially from 1.8 to 2.2.

An apparent shear stress versus apparent shear rate plot is used to identify the melt fracture phenomena. According to Ramamurthy in Journal of Rheology. 30(2), 337-357 (1986) above a certain critical flow rate, the observed extrudate irregularities may be broadly classified into two main types: surface melt fracture and gross melt fracture.

Surface melt fracture occurs under apparently steady flow conditions and ranges in detail from loss of specular gloss to the more severe form of “sharkskin”. In this disclosure, the onset of surface melt fracture is characterized at the beginning of losing extrudate gloss at which the surface roughness of extrudate can only be detected by 40× magnification. The critical shear rate at onset of surface melt fracture for a substantially linear ethylene polymer is at least 50 percent greater than the critical shear rate at the onset of surface melt fracture of a homogeneous linear ethylene polymer having the same I₂ and M_{w}/Mₙ.

Gross melt fracture occurs at unsteady flow conditions and ranges in detail from regular (alternating rough and smooth, helical, etc.) to random distortions. For commercial acceptability, (for example, in blown film products), surface defects should be minimal, if not absent. The critical shear rate at onset of surface melt fracture (OSMF) and onset of gross melt fracture (OGMF) will be used herein based on the changes of surface roughness and configurations of the extrudates extruded by a GER.

The gas extrusion rheometer is described by M. Shida, R. N. Shroff and L. V. Cando in Polymer Engineering Science, Vol. 17, no. 11, p. 770 (1977), and in Rheometers for Molten Plastics by John Dealy, published by Van Nostrand Reinhold Co. (1982) on page 97. All GER experiments are performed at a temperature of 190° C., at nitrogen pressures between 5250 to 500 psig using a 0.0296 inch diameter, 20:1 L/D die. An apparent shear stress vs. apparent shear rate plot is used to identify the melt fracture phenomena. According to Ramamurthy in Journal of Rheology, 30(2), pp. 337-357, (1986), above a certain critical flow rate, the observed extrudate irregularities may be broadly classified into two main types: surface melt fracture and gross melt fracture.

For the polymers described herein, the PI is the apparent viscosity (in Kpoise) of a material measured by GER at a temperature of 190° C., at nitrogen pressure of 2500 psig using a 0.0296 inch diameter, 20:1 L/D die, or corresponding apparent shear stress of 2.15×10⁶ dyne/cm².

The processing index is measured at a temperature of 190° C., at nitrogen pressure of 2500 psig using 0.0296 inch diameter, 20:1 L/D die having an entrance angle of 180°.

Exemplary constrained geometry catalysts for use in polymerizing the homogeneously branched substantially linear ethylene polymers preferentially used to make the novel fibers and other articles of the present invention preferably include those constrained geometry catalysts as disclosed in U.S. application Ser. Nos.: 545,403, filed Jul. 3, 1990; 758,654, now U.S. Pat. No. 5,132,380; 758,660, now abandoned, filed Sep. 12, 1991; and 720,041, now abandoned, filed Jun. 24, 1991, and in U.S. Pat. No. 5,272,236 and U.S. Pat. No. 5,278,272.

As indicated above, substantially random ethylene/vinyl aromatic interpolymers are especially preferred ethylene polymers for use in the present invention. Representative of substantially random ethylene/vinyl aromatic interpolymers are substantially random ethylene/styrene interpolymers preferably containing at least 20, more preferably equal to or greater than 30, and most preferably equal to or greater than 50 weight percent interpolymerized styrene monomer.

A substantially random interpolymer comprises in polymerized form i) one or more □-olefin monomers and ii) one or more vinyl or vinylidene aromatic monomers, or one or more sterically hindered aliphatic or cycloaliphatic vinyl or vinylidene monomers, or a combination thereof, and optionally iii) other polymerizable ethylenically unsaturated monomer(s).

The term “interpolymer” is used herein to indicate a polymer wherein at least two different monomers are polymerized to make the interpolymer.

The term “substantially random” in the substantially random interpolymer resulting from polymerizing i) one or more [symbol] -olefin monomers and ii) one or more vinyl or vinylidene aromatic monomers or one or more sterically hindered aliphatic or cycloaliphatic vinyl or vinylidene monomers, or a combination thereof, and optionally iii) other polymerizable ethylenically unsaturated monomer(s) as used herein generally means that the distribution of the monomers of said interpolymer can be described by the Bernoulli statistical model or by a first or second order Markovian statistical model, as described by J. C. Randall in Polymer Sequence Determination, Carbon-13 NMR Method, Academic Press New York, 1977, pp. 71-78. Preferably, the substantially random interpolymer resulting from polymerizing one or more □-olefin monomers and one or more vinyl or vinylidene aromatic monomers, and optionally other polymerizable ethylenically unsaturated monomer(s), does not contain more than 15 percent of the total amount of vinyl or vinylidene aromatic monomer in blocks of vinyl or vinylidene aromatic monomer of more than 3 units. More preferably, the interpolymer is not characterized by a high degree of either isotacticity or syndiotacticity. This means that in the carbon-13 NMR spectrum of the substantially random interpolymer, the peak areas corresponding to the main chain methylene and methine carbons representing either meso diad sequences or racemic diad sequences should not exceed 75 percent of the total peak area of the main chain methylene and methine carbons.

By the subsequently used term “substantially random interpolymer” it is meant a substantially random interpolymer produced from the above-mentioned monomers.

Suitable [symbol] -olefin monomers which are useful for preparing the substantially random interpolymer include, for example, [symbol] -olefin monomers containing from 2 to 20, preferably from 2 to 12, more preferably from 2 to 8 carbon atoms. Preferred such monomers include ethylene, propylene, butene-1,4-methyl-1-pentene, hexene-1 and octene-1. Most preferred are ethylene or a combination of ethylene with C₃-C₈ [symbol] -olefins. These [symbol] -olefins do not contain an aromatic moiety.

Suitable vinyl or vinylidene aromatic monomers which can be employed to prepare the substantially random interpolymer include, for example, those represented by the following formula I

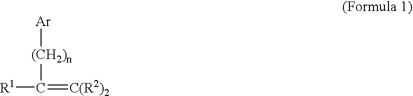

wherein R¹ is selected from the group of radicals consisting of hydrogen and alkyl radicals containing from 1 to 4 carbon atoms, preferably hydrogen or methyl; each R² is independently selected from the group of radicals consisting of hydrogen and alkyl radicals containing from 1 to 4 carbon atoms, preferably hydrogen or methyl; Ar is a phenyl group or a phenyl group substituted with from 1 to 5 substituents; selected from the group consisting of halo, C₁-C₄-alkyl, and C₁-C₄-haloalkyl; and n has a value from zero to 4, preferably from zero to 2, most preferably zero. Particularly suitable such monomers include styrene and lower alkyl- or halogen-substituted derivatives thereof. Exemplary monovinyl or monovinylidene aromatic monomers include styrene, vinyl toluene, [symbol] -methylstyrene, t-butyl styrene or chlorostyrene, including all isomers of these compounds. Preferred monomers include styrene, [symbol] -methyl styrene, the lower alkyl-(C₁-C₄) or phenyl-ring substituted derivatives of styrene, such as for example, ortho-, meta-, and para-methylstyrene, the ring halogenated styrenes, para-vinyl toluene or mixtures thereof. A more preferred aromatic monovinyl monomer is styrene.

By the term “sterically hindered aliphatic or cycloaliphatic vinyl or vinylidene monomers”, it is meant addition polymerizable vinyl or vinylidene monomers corresponding to the formula:

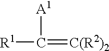

wherein A¹ is a sterically bulky, aliphatic or cycloaliphatic substituent of up to 20 carbons, R¹ is selected from the group of radicals consisting of hydrogen and alkyl radicals containing from 1 to 4 carbon atoms, preferably hydrogen or methyl; each R² is independently selected from the group of radicals consisting of hydrogen and alkyl radicals containing from 1 to 4 carbon atoms, preferably hydrogen or methyl; or alternatively R¹ and A¹ together form a ring system.

By the term “sterically bulky” is meant that the monomer bearing this substituent is normally incapable of addition polymerization by standard Ziegler-Natta polymerization catalysts at a rate comparable with ethylene polymerizations.

[symbol] -Olefin monomers containing from 2 to 20 carbon atoms and having a linear aliphatic structure such as propylene, butene-1, hexene-1 and octene-1 are not considered as sterically hindered aliphatic monomers. Preferred sterically hindered aliphatic or cycloaliphatic vinyl or vinylidene compounds are monomers in which one of the carbon atoms bearing ethylenic unsaturation is tertiary or quaternary substituted. Examples of such substituents include cyclic aliphatic groups such as cyclohexyl, cyclohexenyl, cyclooctenyl, or ring alkyl or aryl substituted derivatives thereof, tert-butyl or norbomyl. Most preferred sterically hindered aliphatic or cycloaliphatic vinyl or vinylidene compounds are the various isomeric vinyl-ring substituted derivatives of cyclohexene and substituted cyclohexenes, and 5-ethylidene-2-norbornene. Especially suitable are 1-, 3-, and 4-vinylcyclohexene.

The substantially random interpolymers usually contain from 0.5 to 65, preferably from 1 to 55, more preferably from 2 to 50 mole percent of at least one vinyl or vinylidene aromatic monomer, or sterically hindered aliphatic or cycloaliphatic vinyl or vinylidene monomer, or a combination thereof, and from 35 to 99.5, preferably from 45 to 99, more preferably from 50 to 98 mole percent of at least one aliphatic [symbol] -olefin having from 2 to 20 carbon atoms.

Other optional polymerizable ethylenically unsaturated monomer(s) include strained ring olefins such as norbomene and C₁-C₁₀-alkyl or C₆-C₁₀-aryl substituted norbornenes, with an exemplary substantially random interpolymer being ethylene/styrene/norbomene.

The most preferred substantially random interpolymers are interpolymers of ethylene and styrene and interpolymers of ethylene, styrene and at least one [symbol] -olefin containing from 3 to 8 carbon atoms.

The number average molecular weight (Mₙ) of the substantially random interpolymers is usually greater than 5,000, preferably from 20,000 to 1,000,000, more preferably from 50,000 to 500,000. The glass transition temperature (T_{g}) of the substantially random interpolymers is preferably from −40° C. to +35° C., preferably from 0° C. to +30° C., preferably from +10° C. to +25° C., measured according to differential mechanical scanning (DMS).

The substantially random interpolymers may be modified by typical grafting, hydrogenation, functionalizing, or other reactions well known to those skilled in the art. The polymers may be readily sulfonated or chlorinated to provide functionalized derivatives according to established techniques. The substantially random interpolymers may also be modified by various chain extending or crosslinking processes including, but not limited to peroxide-, silane-, sulfur-, radiation-, or azide-based cure systems. A full description of the various crosslinking technologies is described in copending U.S. patent application Nos. 08/921,641 and 08/921,642, both filed on Aug. 27, 1997.

Dual cure systems, which use a combination of heat, moisture cure, and radiation steps, may also be effectively employed. Dual cure systems are disclosed and claimed in U.S. patent application Ser. No. 536,022, filed on Sep. 29, 1995, in the names of K. L. Walton and S. V. Karande. For instance, it may be desirable to employ peroxide crosslinking agents in conjunction with silane crosslinking agents, peroxide crosslinking agents in conjunction with radiation, sulfur-containing crosslinking agents in conjunction with silane crosslinking agents, etc.

The substantially random interpolymers may also be modified by various crosslinking processes including, but not limited to the incorporation of a diene component as a termonomer in its preparation and subsequent crosslinking by the aforementioned methods and further methods including vulcanization via the vinyl group using sulfur for example as the cross linking agent.

One suitable method for manufacturing substantially random ethylene/vinyl aromatic interpolymers includes polymerizing a mixture of polymerizable monomers in the presence of one or more metallocene or constrained geometry catalysts in combination with various cocatalysts, as described in EP-A-0,416,815 by James C. Stevens et al. and U.S. Pat. No. 5,703,187 by Francis J. Timmers. Preferred operating conditions for such polymerization reactions include pressures from atmospheric up to 3000 atmospheres and temperatures from −300° C. to 200° C. Polymerizations and unreacted monomer removal at temperatures above the auto-polymerization temperature of the respective monomers may result in formation of some amounts of homopolymer polymerization products resulting from free radical polymerization.

Examples of suitable catalysts and methods for preparing the substantially random interpolymers are disclosed in U.S. application No. 702,475, filed May 20, 1991 (EP-A-514,828); as well as U.S. Pat. Nos.: 5,055,438; 5,057,475; 5,096,867; 5,064,802; 5,132,380; 5,189,192; 5,321,106; 5,347,024; 5,350,723; 5,374,696; 5,399,635; 5,470,993; 5,703,187; and 5,721,185.

The substantially random ethylene/vinyl aromatic interpolymers can also be prepared by the methods described in JP 07/278230 employing compounds shown by the general formula

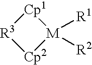

Where Cp¹ and Cp² are cyclopentadienyl groups, indenyl groups, fluorenyl groups, or substituents of these, independently of each other; R¹ and R² are hydrogen atoms, halogen atoms, hydrocarbon groups with carbon numbers of 1-12, alkoxyl groups, or aryloxyl groups, independently of each other; M is a group IV metal, preferably Zr or Hf, most preferably Zr; and R³ is an alkylene group or silanediyl group used to crosslink Cp¹ and Cp².

The substantially random ethylene/vinyl aromatic interpolymers can also be prepared by the methods described by John G. Bradfute et al. (W. R. Grace & Co.) in WO 95/32095; by R. B. Pannell (Exxon Chemical Patents, inc.) in WO 94/00500; and in Plastics Technology p. 25 (September 1992).

Also suitable are the substantially random interpolymers which comprise at least one [symbol] -olefin/vinyl aromatic/vinyl aromatic/ [symbol] -olefin tetrad disclosed in U.S. application Ser. No. 08/708,869, filed Sep. 4, 1996, and WO 98/09999, both by Francis J. Timmers et al. These interpolymers contain additional signals in their carbon-13 NMR spectra with intensities greater than three times the peak to peak noise. These signals appear in the chemical shift range 43.70-44.25 ppm and 38.0-38.5 ppm. Specifically, major peaks are observed at 44.1, 43.9, and 38.2 ppm. A proton test NMR experiment indicates that the signals in the chemical shift region 43.70-44.25 ppm are methine carbons and the signals in the region 38.0-38.5 ppm are methylene carbons.

It is believed that these new signals are due to sequences involving two head-to-tail vinyl aromatic monomer insertions preceded and followed by at least one [symbol] -olefin insertion, for example, an ethylene/styrene/styrene/ethylene tetrad wherein the styrene monomer insertions of said tetrads occur exclusively in a 1,2 (head to tail) manner. It is understood by one skilled in the art that for such tetrads involving a vinyl aromatic monomer other than styrene and an [symbol] -olefin other than ethylene that the ethylene/vinyl aromatic monomer/vinyl aromatic monomer/ethylene tetrad will give rise to similar carbon-13 NMR peaks but with slightly different chemical shifts.

These interpolymers can be prepared by conducting the polymerization at temperatures of from −30° C. to 250° C. in the presence of such catalysts as those represented by the formula:

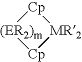

wherein each Cp is independently, each occurrence, a substituted cyclopentadienyl group π-bound to M; E is C or Si; M is a group IV metal, preferably Zr or Hf, most preferably Zr; each R is independently, each occurrence, H, hydrocarbyl, silahydrocarbyl, or hydrocarbylsilyl, containing up to 30, preferably from 1 to 20, more preferably from 1 to 10 carbon or silicon atoms; each R′ is independently, each occurrence, H, halo, hydrocarbyl, hyrocarbyloxy, silahydrocarbyl, hydrocarbylsilyl containing up to 30, preferably from 1 to 20, more preferably from 1 to 10 carbon or silicon atoms or two R′ groups together can be a C₁-C₁₀ hydrocarbyl substituted 1,3-butadiene; M is 1 or 2; and optionally, but preferably in the presence of an activating cocatalyst.

Particularly, suitable substituted cyclopentadienyl groups include those illustrated by the formula:

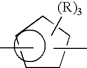

wherein each R is independently, each occurrence, H, hydrocarbyl, silahydrocarbyl, or hydrocarbylsilyl, containing up to 30, preferably from 1 to 20, more preferably from 1 to 10 carbon or silicon atoms or two R groups together form a divalent derivative of such group. Preferably, R independently each occurrence is (including where appropriate all isomers) hydrogen, methyl, ethyl, propyl, butyl, pentyl, hexyl, benzyl, phenyl or silyl or (where appropriate) two such R groups are linked together forming a fused ring system such as indenyl, fluorenyl, tetrahydroindenyl, tetrahydrofluorenyl, or octahydrofluorenyl.

Particularly preferred catalysts include, for example, racemic-(dimethylsilanediyl)-bis-(2-methyl-4-phenylindenyl) zirconium dichloride, racemic-(dimethylsilanediyl)-bis-(2-methyl-4-phenylindenyl) zirconium 1,4diphenyl-1,3-butadiene, racemic-(dimethylsilanediyl)-bis-(2-methyl-4-phenylindenyl) zirconium di-C₁-C₄ alkyl, racemic-(dimethylsilanediyl)-bis-(2-methyl-4-phenylindenyl) zirconium di-C₁-C₄ alkoxide, or any combination thereof.

It is also possible to use the following titanium-based constrained geometry catalysts, [n-(1,1-dimethylethyl)-1,1-dimethyl-1-[(1,2,3,4,5-η)-1,5,6,7-tetrahydro-s-indacen-1- yl]silanaminato(2-)-n]titanium dimethyl; (1-indenyl)(tert-butylamido)dimethyl-silane titanium dimethyl; ((3-tert-butyl)(1,2,3,4,5-η)-1-indenyl)(tert-butylamido) dimethylsilane titanium dimethyl; and ((3-iso-propyl)(1,2,3,4,5-η)-1-indenyl)(tert-butyl amido)dimethylsilane titanium dimethyl, or any combination thereof.

Further preparative methods for the interpolymers used in the present invention have been described in the literature. Longo and Grassi, Makromol. Chem. Volume 191, pages 2387 to 2396 (1990), and D'Anniello et al., Journal of Applied Polymer Science, Volume 58, pages 1701-1706 (1995), report the use of a catalytic system based on methylalurnoxane (MAO) and cyclopentadienyl-titanium trichlorlde (CpTiCl₃) to prepare an ethylene-styrene copolymer. Xu and Lin, Polymer Preprints Am. Chem. Soc., Div. Polym. Chem., Volume 35, pages 686,687 (1994), report copolymerization using a MgCl₂/TiCl_{4/}NdCl₃/Al(iBu)₃ catalyst to give random copolymers of styrene and propylene. Lu et al., Journal of Applied Polymer Science, Volume 53, pages 1453 to 1460 (1994), describe the copolymerization of ethylene and styrene using a TiCl₄/NdCl₃/MgCl₂/al(Et)₃ catalyst. Sernetz and Mulhaupt, Macromol. Chem. Phys., v. 197, pp. 1071-1083, (1997), describe the influence of polymerization conditions on the copolymerization of styrene with ethylene using Me₂Si(Me₄Cp)(n-tert-butyl)TiCl_{2/}Methylaluminoxane Ziegler-Natta catalysts. Copolymers of ethylene and styrene produced by bridged metallocene catalysts are described by Arai, Toshiaki and Suzuki, Polymer Preprints Am. Chem. Soc., Div. Polym. Chem., Volume 38, pages 349, 350 (1997), and in U.S. Pat. No. 5,652,315, issued to Mitsui Toatsu Chemicals, Inc.

Also, the manufacture of [symbol] olefin/vinyl aromatic monomer interpolymers such as propylene/styrene and butene/styrene are described in U.S. Pat. No. 5,244,996, issued to Mitsui Petrochemical Industries Ltd. or U.S. Pat. No. 5,652,315 also issued to Mitsui Petrochemical Industries Ltd. or as disclosed in DE 197 11339 A1 to Denki Kagaku Kogyo KK. Moreover, although of high isotacticity and therefore not “substantially random”, the random copolymers of ethylene and styrene as disclosed in Polymer Preprints, Vol. 39, no. 1, March 1998 by Toru Aria et al. can also be employed as the ethylene polymer of the present invention.

While preparing the substantially random interpolymer, an amount of atactic vinyl aromatic homopolymer may be formed due to homopolymerization of the vinyl aromatic monomer at elevated temperatures. The presence of vinyl aromatic homopolymer is in general not detrimental for the purposes of the present invention and can be tolerated. The vinyl aromatic homopolymer may be separated from the interpolymer, if desired, by extraction techniques such as selective precipitation from solution with a non-solvent for either the interpolymer or the vinyl aromatic homopolymer. Nevertheless, for the purpose of the present invention, it is preferred that no more than 30 weight percent, preferably less than 20 weight percent (based on the total weight of the interpolymers) of atactic vinyl aromatic homopolymer be is present.

The polypropylene and ethylene polymers may be produced via a continuous (as opposed to a batch) controlled polymerization process using at least one reactor for each polymer. But the inventive polymer blend composition itself (or a blend comprising or constituting the polypropylene polymer, or a separate blend comprising or constituting the ethylene polymer, or both) can also be produced using multiple reactors (for example, using a multiple reactor configuration as described in U.S. Pat. No. 3,914,342 (Mitchell)) with the polypropylene polymer being manufactured in one reactor and the ethylene polymer being manufactured in at least one other reactor. The multiple reactors can be operated in series or in parallel, with at least one constrained geometry catalyst employed in at least one of the reactors at a polymerization temperature and pressure sufficient to produce the polypropylene polymer, or the ethylene polymer having the desired properties, or both.

In a preferred embodiment, the polypropylene and ethylene polymers are produced in a continuous process, as opposed to a batch process. Preferably, for the ethylene polymer, the ethylene polymerization or interpolymerization temperature is from 20° C. to 250° C., using constrained geometry catalyst technology. If a narrow molecular weight distribution polymer (M_{w}/Mₙ of from 1.5 to 2.5) having a higher I₁₀/I₂ ratio (for example, I₁₀/I₂ of 7 or more, preferably at least 8, especially at least 9) is desired, the ethylene concentration in the reactor is preferably not more than 8 percent by weight of the reactor contents, especially not more than 4 percent by weight of the reactor contents. Preferably, the polymerization is performed in a solution polymerization process. Generally, manipulation of I₁₀/I₂ while holding M_{w}/Mₙ relatively low for producing the substantially linear polymers described herein is a function of reactor temperature or ethylene concentration or both. Reduced ethylene concentration and higher temperature generally produces higher I₁₀/I₂.

The polymerization conditions for manufacturing the homogeneous linear or substantially linear ethylene polymers used to make the fibers of the present invention are generally those useful in the solution polymerization process, although the application of the present invention is not limited thereto. Slurry and gas phase polymerization processes are also believed to be useful, provided the proper catalysts and polymerization conditions are employed.

One technique for polymerizing the homogeneous linear ethylene polymers useful herein is disclosed in U.S. Pat. No. 3,645,992 (Elston).

In general, the continuous polymerization useful for making the ethylene polymers used in the present invention may be accomplished at conditions well known in the prior art for Ziegler-Natta or Kaminsky-Sinn type polymerization reactions, that is, temperatures from 0 to 250° C. and pressures from atmospheric to 1000 atmospheres (100 MPa).

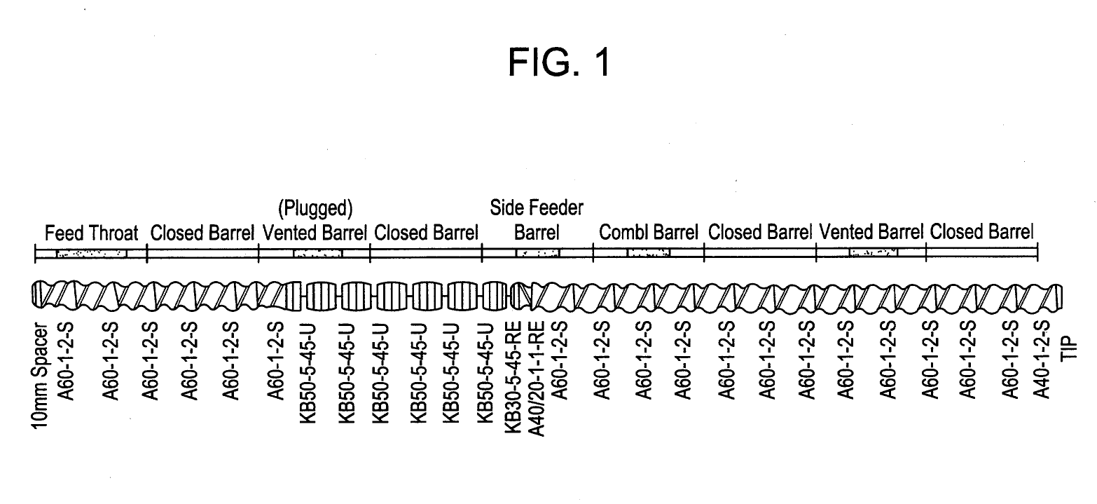

The polymer blend used to make the fibers and fabric of the invention can be formed by any convenient melt blending method, including dry blending the individual components and subsequently melt mixing or by pre-melt mixing in a separate extruder (for example, a Banbury mixer, a Haake mixer, a Brabender internal mixer, or a twin (or single) screw extruder, including pelletization extrusion). Preferably, the inventive polymer blend is formed by melt mixing in a twin-screw co-rotating extruder, more preferably in a twin-screw co-rotating extruder as shown in FIG. 1, and most preferably via in situ blend modification.

Another suitable technique for making the polymer blend is in-situ polymerization of ethylene and propylene using, for example, methods and procedures provided in pending U.S. Ser. No. 08/010,958, entitled “Ethylene Interpolymerizations”, which was filed Jan. 29, 1993 in the names of Brian W. S. Kolthammer and Robert S. Cardwell. U.S. Ser. No. 08/010,958 describes, inter alia, interpolymerizations of ethylene and C₃-C₂₀ alpha-olefins using a homogeneous catalyst in at least one reactor and a heterogeneous catalyst in at least one other reactor and this method can be adapted to employ a polypropylene polymerization reactor as a substitute for the heterogeneous catalyzed ethylene polymerization reactor or as an additional reactor. That is, the in situ polymerization can comprise at least three reactors where at least two reactors provide the ethylene polymer (as a polymer blend composition) and at least one reactor provide the reactor grade polypropylene polymer. For in situ polymerizations, the multiple reactors can be operated sequentially or in parallel. But preferably, when in situ polymerization is used it is only employed to provide suitable ethylene polymers (or ethylene polymer blend compositions) and not the inventive composition itself.

In certain embodiments, the fiber of the invention may be a multiconstituent or multicomponent fiber. Suitable fiber are staple fibers, spunbond fibers, melt blown fibers (using, for example, systems as disclosed in U.S. Pat. No. 4,340,563 (Appel et al.), U.S. Pat. No. 4,663,220 (Wisneski et al.), U.S. Pat. No. 4,668,566 (Braun), U.S. Pat. No. 4,322,027 (Reba), and U.S. Pat. No. 3,860,369), gel spun fibers (for example, the system disclosed in U.S. Pat. No. 4,413,110 (Kavesh et al.)), and flash spun fibers (for example, the system disclosed in U.S. Pat. No. 3,860,369). But preferably the fibers a made by a spunbonding technique.

As defined in The Dictionary of Fiber & Textile Technology, by Hoechst Celanese Corporation, gel spinning refers to “[a] spinning process in which the primary mechanism of solidification is the gelling of the polymer solution by cooling to form a gel filament consisting of precipitated polymer and solvent. Solvent removal is accomplished following solidification by washing in a liquid bath. The resultant fibers can be drawn to give a product with high tensile strength and modulus.”

As defined in The Nonwoven Fabrics Handbook, by John R. Starr, Inc., produced by INDA, Association of the Nonwoven Fabrics Industry, flash spinning refers to “a modified spunbonding method in which a polymer solution is extruded and rapid solvent evaporation occurs so that the individual filaments are disrupted into a highly fibrillar form and are collected on a screen to form a web.”

Staple fibers can be melt spun (that is, they can be extruded into the final fiber diameter directly without additional drawing), or they can be melt spun into a higher diameter and subsequently hot or cold drawn to the desired diameter using conventional fiber drawing techniques. The novel fibers disclosed herein can also be used as bonding fibers, especially where the novel fibers have a lower melting point than the surrounding matrix fibers. In a bonding fiber application, the bonding fiber is typically blended with other matrix fibers and the entire structure is subjected to heat, where the bonding fiber melts and bonds the surrounding matrix fiber. Typical matrix fibers which benefit from use of the novel fibers includes, but is not limited to: poly(ethylene terephthalate) fibers; cotton fibers; nylon fibers; other polypropylene fibers; other heterogeneously branched polyethylene fibers; and linear polyethylene homopolymer fibers. The diameter of the matrix fiber can vary depending upon the end use application.

Suitable fibers can also be in a sheath/core bicomponent fiber configuration (that is, one in which the sheath concentrically surrounds the core). The sheath or the core or both may comprise the inventive polymer blend. Different inventive polymer blends can also be used independently as the sheath and the core in the same fiber and especially where the sheath component has a lower melting point than the core component. Other types of bicomponent fibers are within the scope of the invention as well, and include such structures as side-by-side fibers (for example, fibers having separate regions of polymers, wherein the inventive polymer blend comprises at least a portion of the fiber's surface). One embodiment is in a bicomponent fiber wherein the polymer blend composition disclosed herein is provided in the sheath, and a higher melting polymer, such as polyester terephthalate or a different polypropylene is provided in the core.

The shape of the fiber is not limited. For example, typical fiber have a circular cross sectional shape, but sometimes fibers have different shapes, such as a trilobal shape, or a flat (that is, “ribbon” like) shape. The fiber disclosed herein is not limited by the shape of the fiber.

Fiber diameter can be measured and reported in a variety of fashions. Generally, fiber diameter is measured in denier per filament. Denier is a textile term which is defined as the grams of the fiber per 9000 meters of that fiber's length. Monofilament generally refers to an extruded strand having a denier per filament greater than 15, usually greater than 30. Fine denier fiber generally refers to fiber having a denier of 15 or less. Microdenier (also referred to as “microfiber”) generally refers to fiber having a diameter not greater than 100 micrometers. For the novel fibers disclosed herein, the diameter can be widely varied. But the fiber denier can be adjusted to suit the capabilities of the finished article and as such, would preferably be from 0.5 to 30 denier/filament for melt blown; from 1 to 30 denier/filament for spunbond; and from 1 to 20,000 denier/filament for continuous wound filament.

Fabrics of the invention is are nonwoven fabrics but the laminate or the composite can also comprise other nonwoven or woven plies, or both. Nonwoven fabrics can be made by various technologies, including by spunlacing (or hydrodynamically entangling) fabrics as disclosed in U.S. Pat. No. 3,485,706 (Evans) and U.S. Pat. No. 4,939,016 (Radwanski et al.); by carding and thermally bonding staple fibers; by spunbonding continuous fibers in one continuous operation (with optional thermal bonding); or by melt blowing fibers into fabric and subsequently calendering or thermally bonding the resultant web. These various nonwoven fabric manufacturing techniques are well known to those skilled in the art and the disclosure is not limited to any particular method. Other structures made from such fibers are also included within the scope of the invention, including for example, blends of these novel fibers with other fibers (for example, poly(ethylene terephthalate) (PET) or cotton) to provide, for example, a binder function.

Optional additive materials for use in the present invention include pigments, antioxidants, stabilizers, surfactants (for example, as disclosed in U.S. Pat. No. 4,486,552 (Niemann), U.S. Pat. No. 4,578,414 (Sawyer et al.) or U.S. Pat. No. 4,835,194 (Bright et al.)).

In preferred embodiments of the invention, at bonding temperatures at least 5° F. less than, more preferably, in the range of from 5 to 10° F. lower than the high strain rate optimum bond temperature of the urnmodified (comparative) polypropylene polymer, fabrics prepared from fibers of the invention will exhibit a high strain rate fabric elongation which is at least 20 percent, more preferably greater than or equal to 30 percent, especially greater than or equal to 50 percent and most preferably at least 100 percent higher than the “comparative” fabric. For example, FIG. 4 shows that at a bond temperature of 270° F., Example 1 has a high strain rate fabric elongation of 46 percent compared to only 21 percent for comparative run 1; accordingly, the performance of Example 1 is 119% higher.

In preferred embodiments of the invention, at high strain rates and bonding temperatures at least 5° F. less than, more preferably in the range of 5 to 10° F. lower than the optimum bond temperature of a comparative fabric, the inventive fabric will exhibit a fabric tensile strength which is at least 25 percent, more preferably at least 50 percent, and most preferably at least 70 percent higher than the “comparative” fabric. The improvement is particularly important because attaining a given tenacity at a comparatively lower thermal bonding invariably provides the benefit of enhanced fabric softness.

Useful articles which can be made from the fibers and fabrics disclosed herein include durable and disposable articles such as, for example, diapers, bandages, pantiliners, clean-room apparrel and garments, continence pads, and sanitary napkins. Other useful articles include nonwoven items such as those described in issued U.S. Pat. No. 5,472,775 (Obijeski et al.).

The subject invention is particularly usefully employed in the preparation of calendar roll bonded fabrics such as carded staple fabric or spunbonded fabrics. Exemplary enduse articles include, but not limited to, diaper and other personal hygiene article components, disposable clothing (such as hospital garments), durable clothing (such as insulated outerwear), disposable wipes, dishcloths, and filter media.

The subject invention is also usefully employed in providing carpet or upholstery components, and in providing other webs (such as industrial shipping sacks, strapping and rope, lumber wraps, house/construction wraps, pool covers, geotextiles, and tarpaulins) where controlled elasticity or improved strength is desired or both.

The subject invention may further find utility in adhesive formulations, optionally in combination with one or more tackifiers, plasticizers, or waxes.

### EXAMPLES

In an investigation to determine the high strain rate tensile properties of polypropylene fabrics, a polypropylene homopolymer and three different polypropylene homopolymer/ethylene polymer blends were evaluated. The sample descriptions were as follows:

Example 1 consisted of 90 wt. % of INSPIRE™ H 500-35 (a 35 MFR 230° C./2.16 kg visbroken Ziegler-catalyzed isotactic polypropylene homopolymer, supplied by The Dow Chemical Company) and 10 wt. % AFFINITY™ EG 8100 (a 0.87 g/cc density, 1.0 I₂ MI substantially linear ethylene polymer containing 1800 ppm Irgafos 168, manufactured using a constrained geometry catalyst system, as supplied by The Dow Chemical Company). The polypropylene homopolymer and the ethylene polymer were melt blended together on a twin screw extruder without any additional additives.

Example 2 consisted of 95 wt. % INSPIRE™ H 500-35 and 5 wt. % of the AFFINITY EG 8100. Like Example 1, the polypropylene homopolymer and the ethylene polymer were melt blended together on a twin screw extruder without any additional additives.

Example 3 consisted of 95 wt. % INSPIRE™ H 502-25 (a 25 MFR 230° C./2.16 kg visbroken Ziegler-catalyzed isotactic polypropylene homopolymer, supplied by The Dow Chemical Company) and 5 wt. of the % AFFINITY™ EG 8100. Again, the polypropylene and the ethylene polymer were melt blended together on a twin screw extruder without any additional additives.

Examples 1, 2 and 3 were prepared by tumble dry-blending the polypropylene homopolymer and the ethylene polymer together followed by melt extrusion and pelletization. The melt extrusion and pelletization were performed using a co-rotating twin-screw Werner Pflieder ZSK-30 (30 mm) extruder at a melt temperature of 190° C. The extruder was equipped with positive conveyance elements and no negative conveyance elements.

Comparative run 1 consisted of the INSPIRE™ H 500-35 and comparative run 2 consisted of the INSPIRE™ H 502-25.

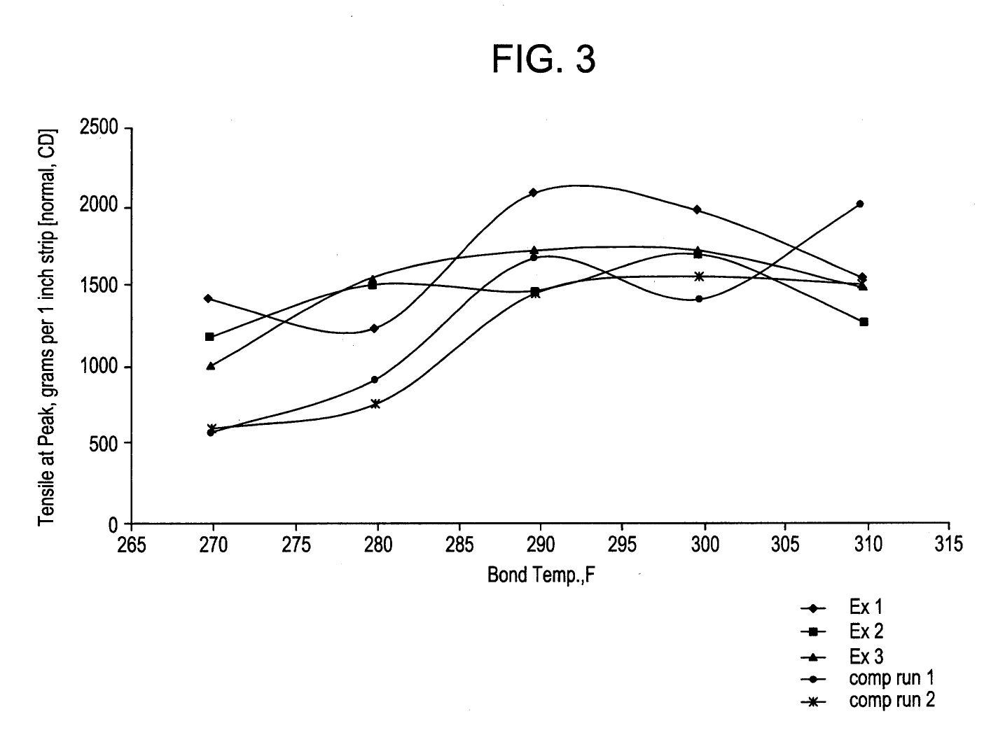

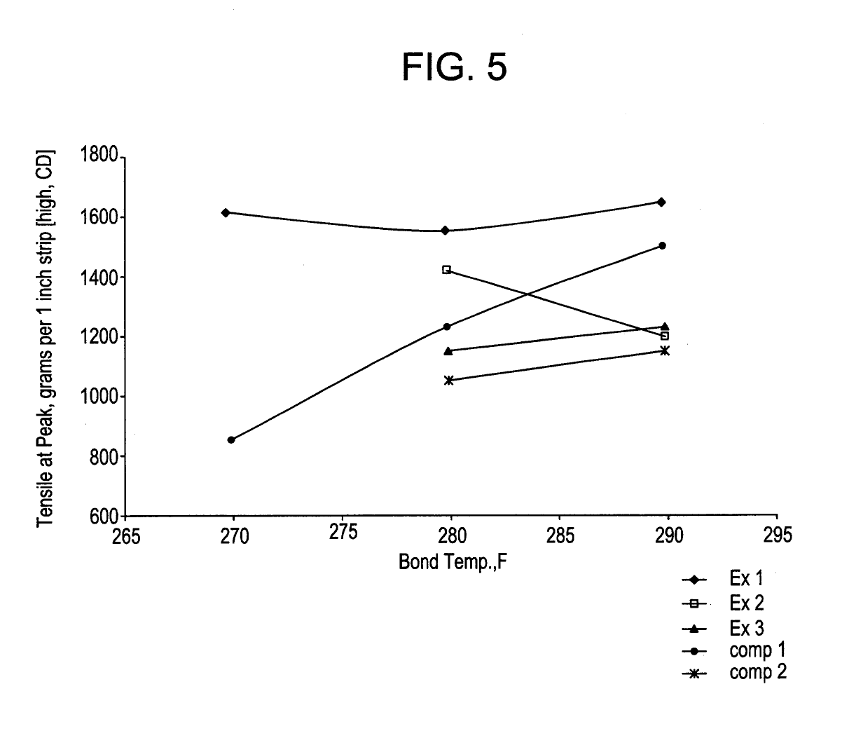

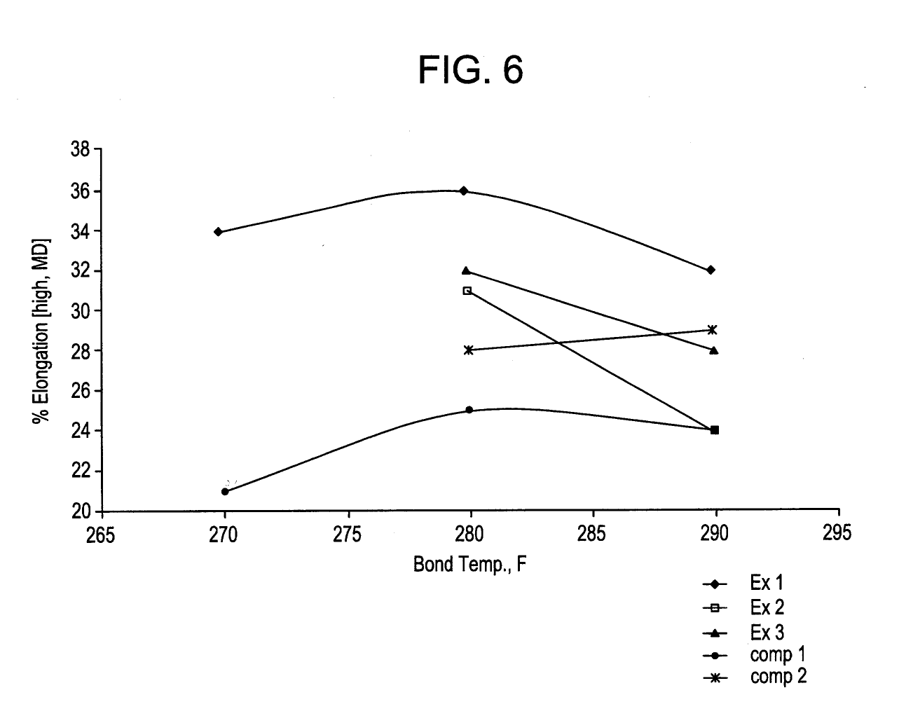

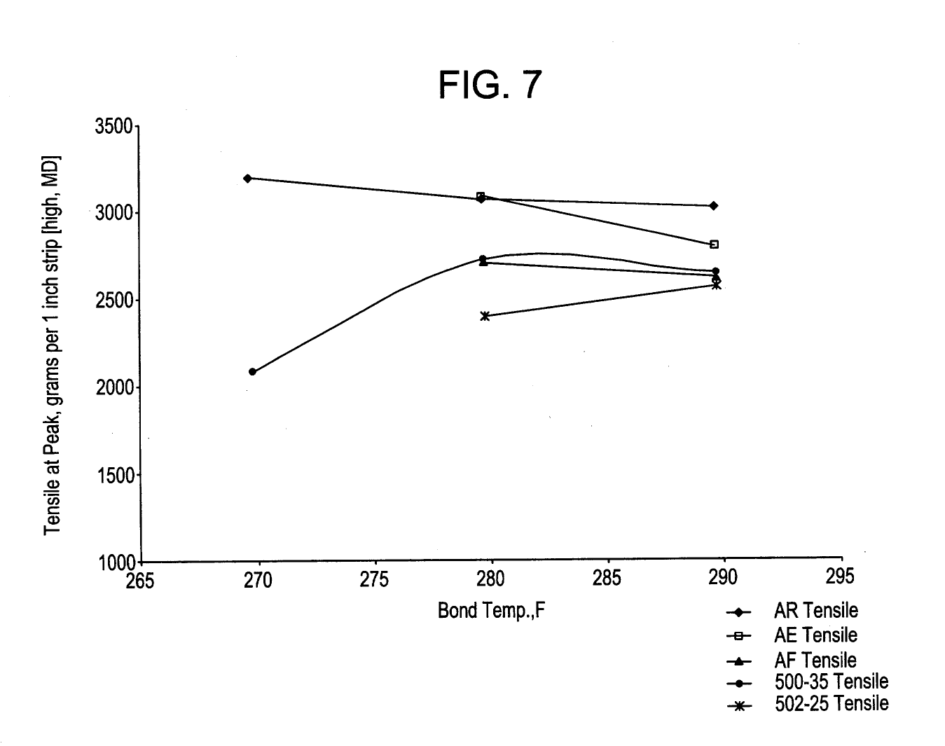

Examples 1, 2 and 3 and comparative runs 1 and 2 were all meltspun into two denier fibers to provide 20 grams/square meter fabric using a a Reicofil II Spun bond line. The die hadd 4,036 holes of 0.6 mm and was fixed with a 250 mesh screen pak. The conditions and settings for Example 1 at an upper roll bond temperature of 280° F. are shown below in Table 1. These conditions and settings were repeated with upper roll bond temperature adjustments to 270° F., 290° F., 300° F. and 310° F., respectively. Examples 2 and 3 and comparative runs 1 and 2 were spunbonded in the same manner as Example 1. The resultant fabrics were then tested at a normal strain rate (that is, 6%/second) and at a high strain rate (that is, 10,000-11,000%/second) for fabric elongation and tensile strength. The tensile property data are reported in Table 2 below and were used to produce FIGS. 2-7.

In another investigation, samples were prepared to evaluate tensile properties of fabrics made using in situ blend modified compositions. In this investigation, the sample descriptions were as follows:

Example 4 consisted of 90 wt. % of a 2 MFR 230° C./2.16 kg Ziegler catalyzed random propylene/ethylene copolymer (99.5 wt.% propylene/0.5 wt.% ethylene) in sphere form and 10 wt. % AFFINITY™ EG 8100 containing 1800 ppm Irgafos 168. The propylene/ethylene copolymer and the ethylene polymer were tumble blended with 2000 ppm Irganox 1010 and 500 calcium stearate (both provided via a single propylene/ethylene copolymer masterbatch concentrate). The tumble blend was fed to a Berstorff ZE40A twin screw extruder (FIG. 1) was viscracked with Lupersol 101 peroxide to provide a 25 MFR 230°/2.16 kg polymer blend composition. The Berstorff extruder comprised a co-rotating, intermeshing, 40 mm twin screw, a 50 Hp drive and was rated for 86 armature amps and 580 rpms screw speed. The extruder had nine (9) zones wherein Zones 1-9 corresponded to the feed throat to the fourth closed barrel in FIG. 1 (that is, the feed throat was Zone 1 and the fourth closed barrel at the tip was Zone 9. Zone temperatures from Zone 2 to Zone 9 were 172° C., 186° C., 172° C., 215° C., 218°C., 231° C, 202° C., 188° C., and 228° C. which provided a die temperature of 228° C. and a melt temperature of 224° C. The feed rate was 240 lbs./hour. The amperage was 71 and the torque was 82%. The actual screw speed was 250 lbs./hour and the die pressure measured 280 psi. The Irgafos 168, antioxidant package was found to critical as without an effective antioxidant package, in excess of quantities soluble in the ethylene polymer (that is, only 800 ppm of Irgafos 168 was soluble in the AFFINITY plastomer), fiber drawability was marginal to poor. That is, simultaneous viscracking and ethylene polymer blending invariably results in excessive crosslinking of the ethylene polymer where an effective stabilizer package is not provided for the ethylene polymer.

Example 5 consisted of 90 wt. % of a 2 MFR 230° C./2.16 kg Ziegler catalyzed random propylene/ethylene copolymer (99.5 wt.% propylene/0.5 wt.% ethylene) in sphere form and 10 wt. % AFFINITY™ EG 8100 containing 1800 ppm Irgafos 168. The propylene/ethylene copolymer and the ethylene polymer were tumble blended with 2000 ppm Irganox 1010 and 500 calcium stearate (both provided via a single propylene/ethylene copolymer masterbatch concentrate). The tumble blend was fed to the Berstorff twin screw extruder (FIG. 1) and viscracked with Lupersol 101 peroxide in a manner similar to that for Example 4 to provide a 35 MFR 230°/2.16 kg polymer blend composition.

Comparative run 3 consisted of viscracking the propylene/ethylene copolymer used for Example 4 in the Berstorff extruder. The propylene/ethylene copolymer was tumble blended with the copolymer masterbatch concentrate to provide 2000 ppm Irganox 1010 and 500 calcium stearate. The tumble blend was fed to a Berstorff twin screw extruder (FIG. 1) and viscracked with Lupersol 101 peroxide to provide a 35 MFR 230°/2.16 kg.

Comparative run 4 consisted of the INSPIRE™ H 500-35.

Example 4 and 5 and comparative runs 3 and 4 were spunbond using the same equipment and substantially the same settings as Example 1, except the collector belt was slowed to provide 30 gsm basis weight.

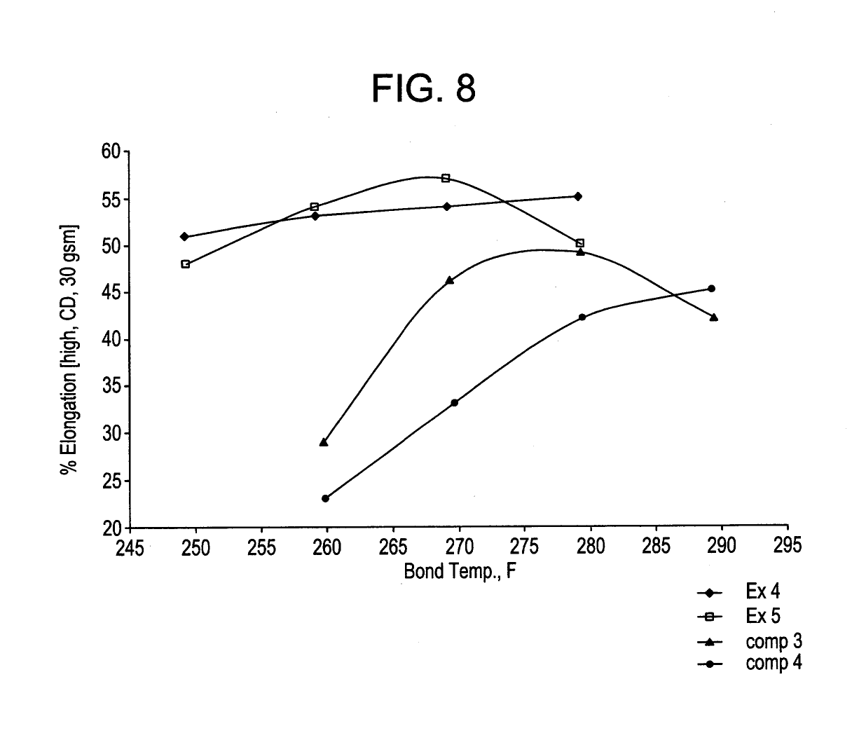

The fabrics of Examples 4 and 5 and comparative runs 3 and 4 were then tested at a normal strain rate (that is, 6%/second) and at a high strain rate (that is, 10,000-11,000%/second) for fabric elongation and tensile strength. The tensile property data are reported in Table 2 below and were used to produce FIG. 8.

Elongation and tensile testing at a “normal” strain rate was performed as follows. Before testing, each fabric specimen was weighed and the weight entered into a computer program. 1 inch×4 inches specimens were cut and positioned lengthwise on a Sintech 10D tensiometer equipped with a 200 pound load cell, such that 1 inch at each end of the specimen was clamped in the top and bottom serrated grips. The specimens were then pulled, one at a time, at 5 inches/minutes to their breaking point. The computer then used the dimensions of the specimen and the force exerted to calculate the percent strain (elongation) experienced by the specimen and the normalized force at break (tensile strength) in grams. Four measurements were taken at each bonding temperature for each example and averaged for the reported tensile strength value.

Elongation and tensile testing at a strain rate of 10,000-11,000%/second was also performed on the spunbonded fabric samples. For the high strain rate testing, a MTS servo-hydraulics load cell test assembly equipped with an oscillator was used. The assembly was purchased in 1984 and underwent a MTS electronics and software upgrade in 1999.

MTS servo-hydraulic load cell assembly and test system included a MTS Model 312.31 55KIP load frame SN1306 with hydraulic lifts and locks and safety shields; a MTS Model 661.11A-01 50 lb load cell SN88196; a MTS Model 205.33 hydraulic actuator rated at 3.3 KIP static force capacity 20 inch total displacement (±10 inches); a MTS Model 256.18AS 180 gpm high flow servo-valve rate capable up to 33,000 in/min with no load; a MTS Model 290.14 hydraulic service manifold (HSM) SN708 50 gpm rated; a MTS Model 510.21B hydraulic power supply (HPS) SN165 rated at 21 gpm; a Temposonic SN010 displacement transducer calibrated for ±10 inches at ±10 volts full scale; and a Nicolet Model 3090 oscillator.

System automation was provided using MTS TestStar V4.0 c software and MTS TestWare SX V4.0 c software. Console electronic was provided using MTS TestStar II and the computer interface was provided using a Compaq DeskPro computer.

The MTS load frame was fitted with an external aluminum load cell frame to ensure isolation from mechanical resonance effects at low load (0.1-50 lbs), high rate (>2,000 in/min) ambient tensile testing. Any other suitable device or procedure may be employed for isolating against mechanical resonance which can interfere with low load, high rate testing accuracy.

TABLE 1

| Example | | Ex. 1 |
|---|---|---|
| gsm | | 20 |
| g/hole/min | | 0.34 |
| fiber microns, 10 fiber avg. | | 17.25 |
| Upper Roll Set (Emboss) | ° C. | 138 |
| Upper Roll Actual | ° C. | 129 |
| (surface) | | |
| Lower Roll Set | ° C. | 135 |
| Lower Roll Actual | ° C. | 127 |
| (surface) | | |
| Extr 1.1 Set | ° C. | 199 |
| Extr 1.1 Actual | ° C. | 199 |
| Extr 1.2 Set | ° C. | 204 |
| Extr 1.2 Actual | ° C. | 204 |
| Extr 1.3 Set | ° C. | 209 |
| Extr 1.3 Actual | ° C. | 209 |
| Extr 1.4 Set | ° C. | 214 |
| Extr 1.4 Actual | ° C. | 216 |
| Extr 1.5 Set | ° C. | 214 |
| Extr 1.5 Actual | ° C. | 215 |
| Scr Chng 2.1 Set | ° C. | 204 |
| Ser Chng 2.1 Actual | ° C. | 204 |
| Scr Chng 2.2 Set | ° C. | 204 |
| Scr Chng 2.2 Actual | ° C. | 204 |
| Conn Zone 3.1 Set | ° C. | 209 |
| Conn Zone 3.1 Actual | ° C. | 211 |
| Conn Zone 3.2 Set | ° C. | 214 |
| Conn Zone 3.2 Actual | ° C. | 212 |
| Spn Pmp 3.3 Set | ° C. | 214 |
| Spn Pmp 3.3 Actual | ° C. | 215 |
| Conn Zone 3.4 Set | ° C. | 214 |
| Conn Zone 3.4 Actual | ° C. | 213 |
| Conn Zone 3.5 Set | ° C. | 214 |
| Conn Zone 3.5 Actual | ° C. | 213 |
| Conn Zone 3.6 Set | ° C. | 214 |
| Conn Zone 3.6 Actual | ° C. | 218 |
| Conn Zone 3.7 Set | ° C. | 214 |
| Conn Zone 3.7 Actual | ° C. | 216 |
| Die Zone 4.1 Set | ° C. | 246 |
| Die Zone 4.1 Actual | ° C. | 246 |
| Die Zone 4.2 Set | ° C. | 239 |
| Die Zone 4.2 Actual | ° C. | 239 |
| Die Zone 4.3 Set | ° C. | 227 |
| Die Zone 4.3 Actual | ° C. | 229 |
| Die Zone 4.4 Set | ° C. | 223 |
| Die Zone 4.4 Actual | ° C. | 223 |
| Die Zone 4.5 Set | ° C. | 227 |
| Die Zone 4.5 Actual | ° C. | 227 |
| Die Zone 4.6 Set | ° C. | 236 |
| Die Zone 4.6 Actual | ° C. | 236 |
| Die Zone 4.7 Set | ° C. | 243 |
| Die Zone 4.7 Actual | ° C. | 243 |
| Die Zone 4.8 Set | ° C. | 218 |
| Die Zone 4.8 Actual | ° C. | 218 |
| Die Zone 4.9 Set | ° C. | 218 |
| Die Zone 4.9 Actual | ° C. | 218 |
| Cascade Zn 3.1 Set | ° C. | 188 |
| Cascade Zn 3.1 Actual | ° C. | 210 |
| Cascade Zn 3.2 Set | ° C. | 199 |
| Cascade Zn 3.2 Actual | ° C. | 247 |
| Spn Pmp Melt Temp | ° C. | 210 |
| Die Melt Temp | ° C. | 229 |
| Spin Pmp Speed | rpm | 15.8 |
| Extr Pressure | MPa | 11 |
| Spin Pmp Pressure | MPa | 8 |
| Die Body Pressure | MPa | 3 |
| Bonder Nip Pressure | kg/mm | 4.6 |
| Extr Speed | rpm | 107 |
| Spin Belt Speed | mpm | 62.6 |
| Bonder Speed | mpm | 62.8 |
| Winder Speed | mpm | 66.8 |
| Cooling Air Temp | ° C. | 19 |
| Suction Air Spd | mpm | 2,435 |
| Cooling Air Spd | mpm | 2,518 |
| Outside Air Temp | ° C. | 12.3 |
| Quench Chmb Press | Pa | 1142 |
| Upr Roll Oil Temp | ° C. | 140 |
| Lwr Roll Oil Temp | ° C. | 134 |

The oscillator was set up to receive input from the load and displacement transducers (on Channel A and B, respectively) and was also set to trigger and capture data a 20 μs/data point from the onset of actuator movement through the displacement range required to produce fabric specimen failure. The channels were set to 10 volts full scale and were also set to match the transducer output as displayed on the TestStar system console.

The load cell and grips were set up by attaching the 50-lb. load cell to the center plate of the external aluminum frame. A 9-inch aluminum extension tube was then attached to the load cell and tensile impact wedge grips with serrated grip surfaces were attached to the actuator and extension tube. The external frame was aligned with the fixtures and securely bolted to the MTS frame with rubber washer placed at all metal-to-metal contact point, including the bottom feet of the external frame.

All cables and hoses of the MTS unit were tranversed and arranged to avoid contact with the external aluminum frame, the gauge length was set to 2.5 inches grip to grip and the actuator was set to full scale displacement ±10 inches (±1 volts).

With the system proper set up, a sharp die and press was used to cut fabric specimen into a 1 inch by 6 inch geometry. The specimen were tabbed to a ½ inch by 1½ inch Kraft butcher white paper strip using Scotch 665 double-coated ½ inch wide adhesive tape. The tab separation established the specimen gauge length at 2.5 inches. Upon visual inspection, the apparent weakest point of each specimen was positioned between the 2.5 inch gauge length and excess material was removed. Given the use of visual inspection for specimen positioning, reported test values are considered to be conservative. Practitioner will recognize that as a suitable alternative to apparent weakest point positioning, random testing of a statistically significant number of specimen will also provide representative results.

To set the system into “ready mode”, the 256 servo-valve was opened and both 252 servo-valves were closed using the valve port shutoffs on the HSM. Valve tuning parameters and the 256 servo-valve driver were set by selecting the 256 servo-valve software configuration file and the system was permitted to warm up for 1 hour.

After the 1 hour warm up time, load displacement controller (referred to as “POD” in the MTS operating manual) was dialed to −10 inch displacement and then compared to the oscilloscope output. Whenever the voltage on oscilloscope differed from that of the load displacement controller, the oscilloscope offset was adjusted to match the output reading of the load displacement controller.

With the system warmed up and the oscillator and the load displacement matched, a TestStar computer file was set up with data acquisition set at 0.0002 seconds/point, physical displacement rate set at 25000 in/Min, the starting displacement set at −10 inches and the ending displacement set at 2 inches.

Once the TestStar computer file was set up, a fabric specimen was loaded in top grip at 8.25 inch displacement with the HSM pressure on low. Next, with the HSM pressure on high, the bottom of the fabric specimen was loaded in the bottom grip and the load displacement controller was dialed to 10 inch displacement. Practitioners will recognize that because of frame dynamics, the actuator will still be accelerating during specimen loading. To account for this, the rate calculation for each run should include the rate at the onset loading and the rate at failure.

To run the test, the load (Channel A) was selected and the cursor was moved to “load onset”. Next, the displacement (Channel B) was selected, the time (in milliseconds) and voltage reading were recorded. Next, the load (Channel A) was selected again and the cursor was moved to “peak load” (that is, maximum load before failure which was taken as the tensile strength of the fabric specimen). Next, the displacement (Channel B) was selected again and the time (in milliseconds) and voltage reading were record. From the second displacement recordation, percent elongation for the fabric specimen was calculated as follows:

% elongation=[[load onset volts from Ch. B−load volts from Ch. B]÷2.5]×100.

For example: [[8.31V−7.515V]÷2.5]×100=32%. Note, 2.5 is the gauge length.

The strain rate for the test was determined by converting volts to millivolts and calculating as follows:

strain rate =[[beginning mV−ending mV]÷[beginning mS−ending mS]]×60. For the high strain rate testing, four (4) fabric specimen per example was measured and avarage to provide the resultant data values.

The results of the normal strain rate and high strain rate testing for Examples 1-5 and comparative runs 1-4 are reported below in Table 2.

Table 2 and FIGS. 2-8 show, relative to the comparative fabrics, the farbics of Examples 1-5 are characterized by higher high strain rate tensile properties and broader bond windows which were also shifted to substantially lower temperatures with regard to maximum tensile properties. Surprisingly, irrespective of MFR differences, elongation improvements of greater than 100% were otbainable for the inventive fabric.

TABLE 2
CROSS DIRECTION, 20 gsm fabric, 2 dn fiber (@ normal, 6%/sec; specimens: 1″ width,
2″ gauge length, 5 inch/min)

| | 270 F. | | 280 F. | | 290 F. | | 300 F. | | 310 F. | |
|---|---|---|---|---|---|---|---|---|---|---|
| | Bond Temp | | Bond Temp | | Bond Temp | | Bond Temp | | Bond Temp | |
| | Tensile | % elong | Tensile | % elong | Tensile | % elong | Tensile | % elong | Tensile | % elong |
| Material | | | | | | | | | | |
| Ex 1 | 1424 | 70 | 1231 | 96 | 2092 | 100 | 1981 | 86 | 1542 | 68 |
| Ex 2 | 1184 | 54 | 1509 | 70 | 1463 | 77 | 1699 | 73 | 1257 | 51 |
| Ex 3 | 998 | 53 | 1551 | 78 | 1725 | 79 | 1718 | 72 | 1482 | 63 |
| Comp 1 | 578 | 34 | 908 | 29 | 1676 | 74 | 1407 | 55 | 2014 | 38 |
| Comp 2 | 604 | 32 | 752 | 34 | 1453 | 62 | 1555 | 77 | 1499 | 64 |

(@ high speed, 11,000%/sec; specimens: 1 inch width, 2.5 inch gage length, 16,500 inch/min)

| | | | | | | |
|---|---|---|---|---|---|---|
| Material | | | | | | |
| Ex 1 | 1614 | 46 | 1554 | 44 | 1647 | 43 |
| Ex 2 | | | 1420 | 37 | 1198 | 37 |
| Ex 3 | | | 1151 | 36 | 1231 | 33 |
| Comp 1 | 854 | 21 | 1231 | 34 | 1501 | 31 |
| Comp 2 | | | 1053 | 31 | 1150 | 29 |

MACHINE DIRECTION VALUES, 20 gsm fabric, 2 dn fiber (@ normal, 6%/sec;
specimens: 1 inch width, 2 inch gage length, 5 inch/min)

| | | | | | | | | | | |
|---|---|---|---|---|---|---|---|---|---|---|
| Material | | | | | | | | | | |
| Ex 1 | 2649 | 74 | 3417 | 93 | 3366 | 83 | 2799 | 70 | 2990 | 60 |
| Ex 2 | 1567 | 37 | 2802 | 74 | 2887 | 71 | 2922 | 65 | 2379 | 40 |
| Ex 3 | 1957 | 37 | 2875 | 80 | 3156 | 84 | 3145 | 78 | 2619 | 54 |
| Comp 1 | 900 | 16 | 1937 | 31 | 2871 | 62 | 2602 | 51 | 1614 | 56 |
| Comp 2 | 846 | 13 | 1338 | 34 | 2534 | 60 | 2740 | 65 | 2773 | 56 |

(@ high speed, 10,333%/sec; specimens: 1 inch width, 2.5 inch gage length, 15,500 inch/min)

| Example | | | | | | | | | | |
|---|---|---|---|---|---|---|---|---|---|---|
| Ex 1 | 3183 | 34 | 3065 | 36 | 3017 | 32 | | | | |
| Ex 2 | | | 3077 | 31 | 2793 | 24 | | | | |
| Ex 3 | | | 2699 | 32 | 2610 | 28 | | | | |
| Comp 1 | 2087 | 21 | 2721 | 25 | 2638 | 24 | 2926 | 21 | | |
| Comp 2 | | | 1053 | 31 | 1150 | 29 | | | | |
| | 250 F. | | 260 F. | | 270 F. | | 280 F. | | 290 F. | |
| | Bond Temp | | Bond Temp | | Bond Temp | | Bond Temp | | Bond Temp | |
| | Tensile | % elong | Tensile | % elong | Tensile | % elong | Tensile | % elong | Tensile | % elong |

CROSS DIRECTION VALUES, 30 gsm fabric, 2 dn fiber
(@ normal, 6%/sec; specimens: 1 inch width, 2 inch gage length, 5 inch/min)

| | | | | | | | | | | |
|---|---|---|---|---|---|---|---|---|---|---|
| Example | | | | | | | | | | |
| Ex 4 | 1690 | 62 | 2320 | 77 | 2915 | 107 | 3242 | 113 | 3159 | 121 |
| Ex 5 | 1873 | 76 | 2106 | 94 | 2575 | 108 | 2626 | 112 | 2732 | 115 |
| Comp 3 | 729 | 44 | 796 | 25 | 1069 | 29 | 1752 | 43 | 2552 | 79 |
| Comp 4 | 568 | 27 | 751 | 21 | 997 | 25 | 1462 | 34 | 2031 | 53 |

(@ high speed, 10,667%/sec; specimens: 1 inch width, 2.5 inch gage length, 16,500 inch/min)

| | | | | | | | | | | |
|---|---|---|---|---|---|---|---|---|---|---|
| Example | | | | | | | | | | |
| Ex 4 | 2486 | 51 | 2554 | 53 | 2948 | 54 | 2736 | 55 | 2553 | 50 |
| Ex 5 | 2219 | 48 | 2511 | 54 | 2620 | 57 | 2386 | 50 | 1819 | 42 |
| Comp 3 | | | 1267 | 29 | 1765 | 46 | 2175 | 49 | 2383 | 42 |
| Comp 4 | | | 1355 | 23 | 1368 | 33 | 2025 | 42 | 1813 | 45 |

MACHINE DIRECTION VALUES, 30 gsm fabric, 2 dn fiber
(@ normal, 6%/sec; specimens: 1 inch width, 2 inch gage length, 5 inch/min)

| | | | | | | | | | | |
|---|---|---|---|---|---|---|---|---|---|---|
| Example | | | | | | | | | | |
| Ex 4 | 3380 | 54 | 4340 | 81 | 4842 | 100 | 4999 | 109 | 5019 | 98 |
| Ex 5 | 3448 | 74 | 4151 | 98 | 4580 | 106 | 4245 | 100 | 4376 | 92 |
| Comp 3 | 1375 | 11 | 1690 | 14 | 2182 | 21 | 3059 | 37 | 4163 | 66 |
| Comp 4 | 1272 | 10 | 1576 | 12 | 1922 | 18 | 2596 | 24 | 3715 | 46 |

We claim:

1. A method of making a non-woven fabric comprising providing a fabric comprising a plurality of fibers which comprise at least one polypropylene polymer and at least one ethylene polymer; bonding the fabric at a bond temperature of from 15 to 20° F. lower than an optimum bond temperature of a comparative fabric, measured at a strain rate of 6% per second, to form an improved high strain rate fabric, wherein the comparative fabric comprises fibers of the polypropylene polymer without the ethylene polymer, and wherein the fabric tensile elongation is at least 20 percent greater than the comparative fabric at strain rates in the range from 10,000 to 11,000% per second.

3. The method of claim 1 wherein the improved non-woven fabric has a Cross Direction percent elongation at a bond temperature of 270° F. and 20 gsm basis weight of at least 35 at a strain rate greater than or equal to 100%/second.

4. The method of claim 1 wherein the improved non-woven fabric has a Cross Direction percent elongation at a bond temperature of 270° F. and 20 gsm basis weight of at least 35 at a strain rate greater than or equal to 500%/second.

5. The method of claim 1 wherein the improved non-woven fabric has a Cross Direction percent elongation at a bond temperature of 270° F. and a basis weight of 20 gsm of at least 35 at a strain rate greater than or equal to 1000%/second.

6. The method of claim 1 wherein the improved non-woven fabric has a Cross Direction percent elongation at a bond temperature of 270° F. and 20 gsm basis weight of at least 35 at a strain rate greater than or equal to 5,000%/second.

7. The method of claim 1 wherein the improved non-woven fabric has a Cross Direction percent elongation at a bond temperature of 270° F. and 20 gsm basis weight of at least 35 at a strain rate greater than or equal to 10,000%/second.

8. The method of claim 1 wherein the improved non-woven fabric, thermally bonded at a surface temperature 20° F. lower than the optimum bond temperature (which is that temperature that provides the maximum high strain rate fabric elongation) for a comparative fabric, is characterized as having a Cross-Direction percent fabric elongation, measured at 10,500%/second, of at least 30 percent higher than the comparative fabric, wherein the comparative fabric is made without the ethylene polymer and with the same polypropylene polymer at the same basis weight as the improved fabric (that is, the comparative fabric is essentially the same as the improved fabric, except for the addition of the at least one ethylene polymer).

9. The method of claim 1 wherein the improved non-woven fabric, thermally bonded at a surface temperature 20° F. lower than the optimum bond temperature for a comparative fabric, is characterized as having a Cross-Direction percent fabric elongation, measured at 10,500%/second, of at least 50 percent higher than the comparative fabric, wherein the comparative fabric is made without the ethylene polymer and with the same polypropylene polymer at the same basis weight as the improved fabric.

10. The method of claim 1 wherein the improved non-woven fabric has a Cross Direction percent fabric elongation of at least 35, when bonded and at a basis weight of at least 18 gsm and measured at a strain rate in the range of from 10,000 to 11,000%/second.

11. The method of claim 1 wherein the polypropylene polymer is an in situ blend modified polypropylene polymer.

12. The method of claim 1 wherein the polypropylene polymer has a melt flow rate of greater than or equal to 25 g/10 minutes, as measured in accordance with ASTM D1238 Condition 230° C./2.16 kg.

13. The method of claim 1 wherein the ethylene polymer is a homogeneously branched ethylene polymer (that is, has a SCBDI of greater than 50 percent).

14. The method of claim 13 wherein the homogeneously branched ethylene polymer is a substantially linear ethylene/α-olefin interpolymer characterized having
i. a melt flow ratio, I₁₀/I₂≧5.63,
ii. a molecular weight distribution, M_{w}/Mₙ, defined by the equation:
M_{w}/Mₙ≦(I₁₀/I₂)−4.63, and
iii. a critical shear rate at onset of surface melt fracture of at least 50 percent greater than the critical shear rate at the onset of surface melt fracture of a linear ethylene polymer having about the same I₂ and M_{w}/Mₙ.

15. The method of claim 13 wherein the homogeneously branched ethylene polymer is a homogeneously branched linear ethylene polymer (that is, characterized as having less than 0.01 long chain branch per 1000 carbons as well as short chain branching distribution index (SCBDI) of greater than 50 percent).

16. The method of claim 15 wherein the homogeneously branched linear ethylene polymer is further characterized as having a single differential scanning calorimetry (DSC) melt point between −30° and 150° C.

17. The method of claim 1, wherein fibers comprise from 0.5 to 22 weight percent of the ethylene polymer.

18. The method of claim 1, wherein the ethylene polymer is an interpolymer of ethylene and at least one C₃-C₂₀ α-olefin.

19. The method of claim 1, wherein the ethylene polymer has a density of from 0.855 to 0.880 gram/centimeters³.

20. The method of claim 1, wherein the ethylene polymer has a melt index of from 0.01 to 10 gram/10 minutes.

21. The method of claim 1, wherein the ethylene polymer has a melt index less than 5 gram/10 minutes.

22. The method of claim 1, wherein the polypropylene polymer is a visbroken polypropylene and has a melt flow rate at 230° C./2.16 kg of greater than or equal 20 g/10 minutes.

23. The method of claim 1, wherein the polypropylene polymer has a coupled melt flow rate at 230° C./2.16 kg of greater than or equal 20 g/10 minutes.

24. The method of claim 23, where the polypropylene polymer is coupled using an azide.

25. The method of claim 1, wherein the polypropylene polymer is manufactured using at least one single-site, metallocene or constrained geometry catalyst system.

26. The method of claim 23, wherein the polypropylene polymer before being coupled is manufactured using a single-site, metallocene or constrained geometry catalyst system.

27. The method of claim 25, wherein the polypropylene polymer is manufactured using at least one constrained geometry catalyst system.

28. The method of claim 26, wherein the polypropylene polymer before coupling is manufactured using at least one constrained geometry catalyst system.

29. The method of claim 1, wherein the polypropylene polymer is characterized as having at least 96 percent weight isotacticity.

30. The method of claim 1, wherein the fibers are prepared by a melt spinning process such that the fibers are melt blown fibers, spunbonded fibers, carded staple fibers or flash spun fibers.

31. The method of claim 20 wherein the ethylene polymer is blended with the polypropylene polymer at greater than or equal to 3 weight percent, based on the total weight of the ethylene polymer and the polypropylene polymer.

32. The method of claim 22 wherein the ethylene polymer is blended with the polypropylene polymer at greater than or equal to 3 weight percent, based on the total weight of the ethylene polymer and the polypropylene polymer.

33. The method of claim 31 wherein the density of the ethylene polymer is less than or equal to 0.89 g/cc.

34. The method of claim 1 wherein the polypropylene polymer is a random copolymer containing 0.1 to 10 weight percent ethylene.

35. The method of claim 1 wherein the polypropylene polymer is a polypropylene homopolymer.

36. A method of making a film-fabric laminate comprising bonding the film and fabric to form a laminate and stretching the laminate at a strain rate in the range from 10,000 to 11,000% per second, wherein the fabric is a nonwoven thermally bonded fabric comprising a plurality of fibers comprised of a melt blend of at least one polypropylene polymer and at least one ethylene polymer, wherein the fabric has a tensile elongation of at least 20 percent greater than the comparative fabric, wherein the comparative fabric comprises fibers of the polypropylene polymer without the ethylene polymer, wherein the film is elongatable and the method.

37. The non-woven fabric obtainable by the method of claim 1.

38. The film-fabric laminate obtainable by the method of claim 36.

39. The method of claim 11 wherein the polypropylene polymer is a random copolymer containing 0.1 to 10 weight percent ethylene.

40. The method of claim 11 wherein the polypropylene polymer is a polypropylene homopolymer.
